(19) United States
(12) Patent Application Publication
(10) Pub. No.: US 2015/0310522 A1
(43) Pub. Date: Oct. 29, 2015

(54) SALES SYSTEM, SALES APPARATUS, SALES PROGRAM, COMPUTER-READABLE RECORDING MEDIUM ON WHICH SALES PROGRAM IS RECORDED, AND SALES METHOD

(71) Applicant: Rakuten, Inc., Tokyo (JP)

(72) Inventor: Rei Kashima, Tokyo (JP)

(73) Assignee: Rakuten, Inc., Tokyo (JP)

(21) Appl. No.: 14/441,226

(22) PCT Filed: Dec. 28, 2012
(86) PCT No.: PCT/JP2012/084083

§ 371 Date: May 7, 2015

(51) Int. Cl. G06Q 30/06

(52) U.S. Cl. CPC G06Q 30/0623; G06Q 30/0635

(57) ABSTRACT

A sales apparatus (200) comprises a selector (240) selecting multiple stores selling a product using the sales modes of the product at the stores and multiple mutually different selection conditions for selecting the stores individually using the sales modes. The sales apparatus (200) further comprises a first outputter (251) outputting multiple pieces of information associating and presenting operation objects associated with any of the multiple selected stores and the sales modes of the product at the stores associated with the operation objects. The sales apparatus (200) further comprises an information inputter (230) entering operation information presenting which operation object is operated by the user and a second outputter (252) outputting information indicating that the user has placed an order for purchasing the product with its destination set to the store terminal used by the store associated with the operation object presented by the entered operation information.

### TECHNICAL FIELD

The present disclosure relates to a sales system, sales apparatus, sales program, computer-readable non-transitory recording medium on which the sales program is recorded, and sales method.

### BACKGROUND ART

Systems acquiring information identifying a product a user wishes to purchase and displaying the name of the store that sells the product at the lowest price and that lowest price are known (for example, Patent Literature 1).

### CITATION LIST

### Patent Literature

Patent Literature 1: Unexamined Japanese Patent Application Kokai Publication No. 2009-048284.

### SUMMARY OF INVENTION

### Technical Problem

However, for example, when the user is not interested in purchasing a product at a lower price, the system described in the Patent Literature 1 cannot present the product sold in the mode suitable for the user's interest. Therefore, the system described in the Patent Literature 1 has a problem that a product is not sold in the mode suitable for the user's interest.

The present disclosure is made with the view of the above aspect and the objective of the disclosure is to provide a sales system, sales apparatus, sales program, computer-readable non-transitory recording medium on which the sales program is recorded, and sales method for making it possible to sell a product in the mode suitable for the user's interest.

### Solution to Problem

In order to achieve the above objective, the sales system according to a first exemplary aspect of the present disclosure comprises:
a selector selecting a plurality of stores selling a product a user wishes to purchase using sales modes of the product at the stores and a plurality of mutually different selection conditions for selecting the stores individually using the sales modes;
a presenter associating and presenting to the user a plurality of operation objects associated with any of the plurality of selected stores and the sales modes of the product at the stores associated with the operation objects;
an inputter entering operation information presenting which operation object is operated by the user among the plurality of operation objects; and
an informer informing the store associated with the operated operation object that the user has placed an order for purchasing the product.

It is further possible in the sales system according to the first exemplary aspect that:
the informer informs the plurality of selected stores of the selection condition for selecting the store using the sales modes that is associated with the operated operation object.

It is further possible in the sales system according to the first exemplary aspect that:
the selector selects the plurality of stores based on the ranks of the stores selling the product the user wishes to purchase that are given using the sales modes of the product at the stores and the plurality of mutually different conditions for selecting the stores individually using the sales modes, and
the informer informs stores different from the plurality of selected stores among the stores selling the product the user withes to purchase of the ranks given using the selection condition used in selecting the store associated with the operated operation object.

It is further possible in the sales system according to the first exemplary aspect that:
at least one of the plurality of selection conditions is a bundled sale condition using a number of pieces in a bundle to sell the product,
an area count identifier identifying a number of image areas presenting the product in each of images presenting the product that are extracted from webpages used by the plurality of stores for selling the product is further provided, and
the selector selects a store satisfying at least one bundled sale condition from the stores selling the product the user wishes to purchase on an assumption that the identified number of image areas is a number of pieces in a bundle to sell the product.

It is further possible that the sales system according to the first exemplary aspect further comprises:
a creator creating a new selection condition based on the sales mode in which the product is sold at the store associated with the operated operation object, wherein
the selector selects multiple stores using the new selection condition created.

In order to achieve the above objective, the sales apparatus according to a second exemplary aspect of the present disclosure comprises:
a selector selecting a plurality of stores selling a product a user wishes to purchase using sales modes of the product at the stores and a plurality of mutually different selection conditions for selecting the stores individually using the sales modes;
a first outputter outputting to a user terminal used by the user a plurality of information associating and presenting operation objects associated with any of the plurality of selected stores and the sales modes of the product at the stores associated with the operation objects;
an information inputter entering from the user terminal operation information presenting which operation object is operated by the user among the plurality of operation objects; and
a second outputter outputting information indicating that the user has placed an order for purchasing the product with its destination set to a store terminal used by the store associated with the operation object presented by the entered operation information.

In order to achieve the above objective, the sales program according to a third exemplary aspect of the present disclosure allows a computer to function as:
a selector selecting a plurality of stores selling a product a user wishes to purchase using sales modes of the product at the stores and a plurality of mutually different selection conditions for selecting the stores individually using the sales modes;
a first outputter outputting to a user terminal used by the user a plurality of information associating and presenting operation objects associated with any of the plurality of selected stores and the sales modes of the product at the stores associated with the operation objects;
an information inputter entering from the user terminal operation information presenting which operation object is operated by the user among the plurality of operation objects; and
a second outputter outputting information indicating that the user has placed an order for purchasing the product with its destination set to a store terminal used by the store associated with the operation object presented by the entered operation information.

In order to achieve the above objective, the non-transitory recording medium according to a fourth exemplary aspect of the present disclosure records a sales program that allows a computer to function as:
a selector selecting a plurality of stores selling a product a user wishes to purchase using sales modes of the product at the stores and a plurality of mutually different selection conditions for selecting the stores individually using the sales modes;
a first outputter outputting to a user terminal used by the user a plurality of information associating and presenting operation objects associated with any of the plurality of selected stores and the sales modes of the product at the stores associated with the operation objects;
an information inputter entering from the user terminal operation information presenting which operation object is operated by the user among the plurality of operation objects; and
a second outputter outputting information indicating that the user has placed an order for purchasing the product with its destination set to a store terminal used by the store associated with the operation object presented by the entered operation information.

In order to achieve the above objective, the sales method according to a fifth exemplary aspect of the present disclosure comprises:
a selection step of selecting a plurality of stores selling a product a user wishes to purchase using sales modes of the product at the stores and a plurality of mutually different selection conditions for selecting the stores individually using the sales modes;
a first output step of outputting to a user terminal used by the user a plurality of information associating and presenting operation objects associated with any of the plurality of selected stores and the sales modes of the product at the stores associated with the operation objects;
an information input step of entering from the user terminal operation information presenting which operation object is operated by the user among the plurality of operation objects; and
a second output step of outputting information indicating that the user has placed an order for purchasing the product with its destination set to a store terminal used by the store associated with the operation object presented by the entered operation information.

### Advantageous Effects of Invention

The sales system, sales apparatus, sales program, computer-readable non-transitory recording medium on which the sales program is recorded, and sales method according to the present disclosure makes it possible to sell a product in the mode suitable for the user's interest.

### BRIEF DESCRIPTION OF DRAWINGS

FIG. 1 is a system configuration diagram presenting an exemplary system configuration of the sales system according to an embodiment of the present disclosure;

FIG. 2 is an illustration presenting an example of the search results screen displayed by the user terminal in the embodiment;

FIG. 3 is a hardware configuration diagram presenting an exemplary configuration of the sales apparatus;

FIG. 4 is a flowchart presenting an example of the sales procedure executed by the sales apparatus in the embodiment;

FIG. 5 is a functional block diagram presenting exemplary functions exerted by the sales apparatus in the embodiment;

FIG. 6 is an illustration presenting an example of the products table stored by the information storage in the embodiment;

FIG. 7 is an illustration presenting an example of the sales modes table stored by the information storage in the embodiment;

FIG. 8 is an illustration presenting an example of the selection conditions table stored by the information storage in the embodiment;

FIG. 9A is an illustration presenting a first example of the evaluation table created by the selector in the embodiment;

FIG. 9B is an illustration presenting a second example of the evaluation table created by the selector in the embodiment;

FIG. 10A is an illustration presenting a third example of the evaluation table created by the selector in the embodiment;

FIG. 10B is an illustration presenting a fourth example of the evaluation table created by the selector in the embodiment;

FIG. 11 is an illustration presenting an example of the search results screen displayed by the user terminal in Modified Embodiment 1;

FIG. 12 is an illustration presenting an example of the search results screen displayed by the user terminal in Modified Embodiment 2;

FIG. 13 is an illustration presenting an example of the search results screen displayed by the user terminal in Modified Embodiment 3;

FIG. 14 is a partial flowchart presenting an example of the sales procedure executed by the sales apparatus in Modified Embodiment 4;

FIG. 15 is an illustration presenting an example of the usage count table stored by the information storage in Modified Embodiment 6;

FIG. 16 is a partial flowchart presenting an example of the creation procedure executed by the sales apparatus in Modified Embodiment 6;

FIG. 17 is a functional block diagram presenting exemplary functions exerted by the sales apparatus in Modified Embodiment 6;

FIG. 18 is an illustration presenting an example of the selection conditions table stored by the information storage in Modified Embodiment 6;

FIG. 19 is an illustration presenting an example of the sales modes table stored by the information storage in Modified Embodiment 7;

FIG. 20 is a partial flowchart presenting an example of the sales unit identification procedure executed by the sales apparatus;

FIG. 21 is a functional block diagram presenting exemplary functions exerted by the sales apparatus in Modified Embodiment 7;

FIG. 22 is an illustration presenting an example of the selection conditions table stored by the information storage in Modified Embodiment 7;

FIG. 23 is an illustration presenting an example of the evaluation table created by the selector in Modified Embodiment 7; and

FIG. 24 is an illustration presenting an example of the products table stored by the information storage in Modified Embodiment 8.

### DESCRIPTION OF EMBODIMENTS

An embodiment of the present disclosure will be described hereafter with reference to the attached drawings.

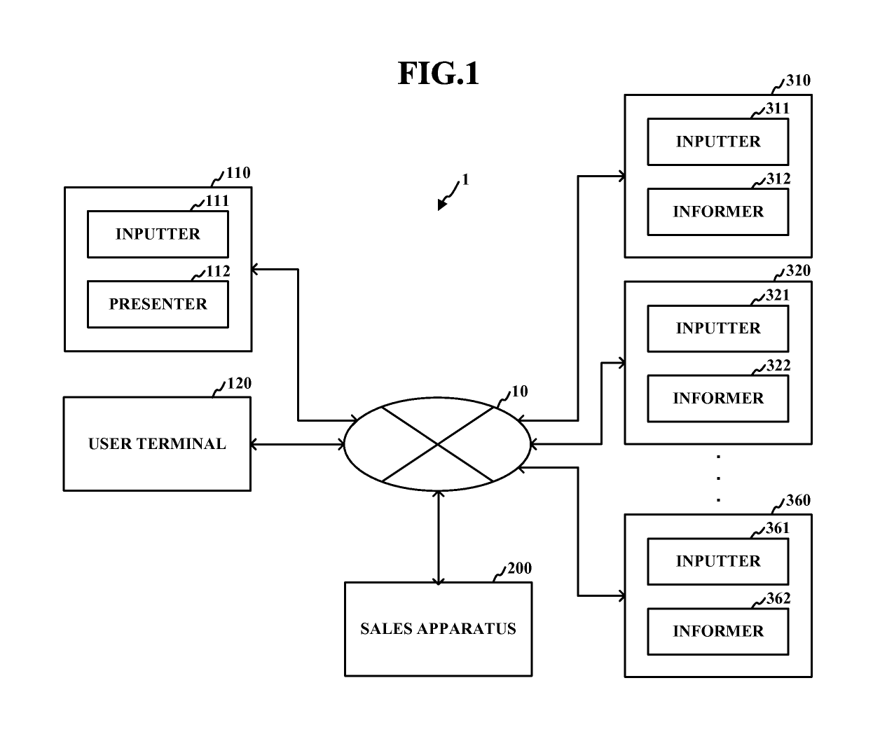

A sales system 1 in FIG. 1 comprises a computer communication network 10, user terminals 110 and 120, a sales apparatus 200, and store terminals 310 to 360.

The computer communication network 10 is configured by, for example, the Internet. The computer communication network 10 can be a LAN (local area network) or public line network.

The user terminal 110 comprises an inputter 111 configured by, for example, a keyboard and a presenter 112 configured by, for example, an LCD (liquid crystal display). The store terminal 310 comprises an inputter 311 configured by, for example, a keyboard and an informer 312 configured by, for example, an LCD.

The inputters 111 and 311 each can be configured by any of, for example, a mouse, touch pad, and touch panel. Furthermore, the presenter 112 and informer 312 each can be configured by any of, for example, a PDP (plasma display panel) and EL (electroluminescence) display.

The user terminal 120 has the same configuration and function as the user terminal 110. The store terminals 320 to 360 each have the same configuration and function as the store terminal 310. The store terminals 320 and 360 have an inputter 321 and informer 322 and an inputter 361 and informer 362 corresponding to the inputter 311 and informer 312 of the store terminal 310, respectively.

The following explanation will be made using a case in which the user operates the user terminal 110 to purchase a desired product by way of example.

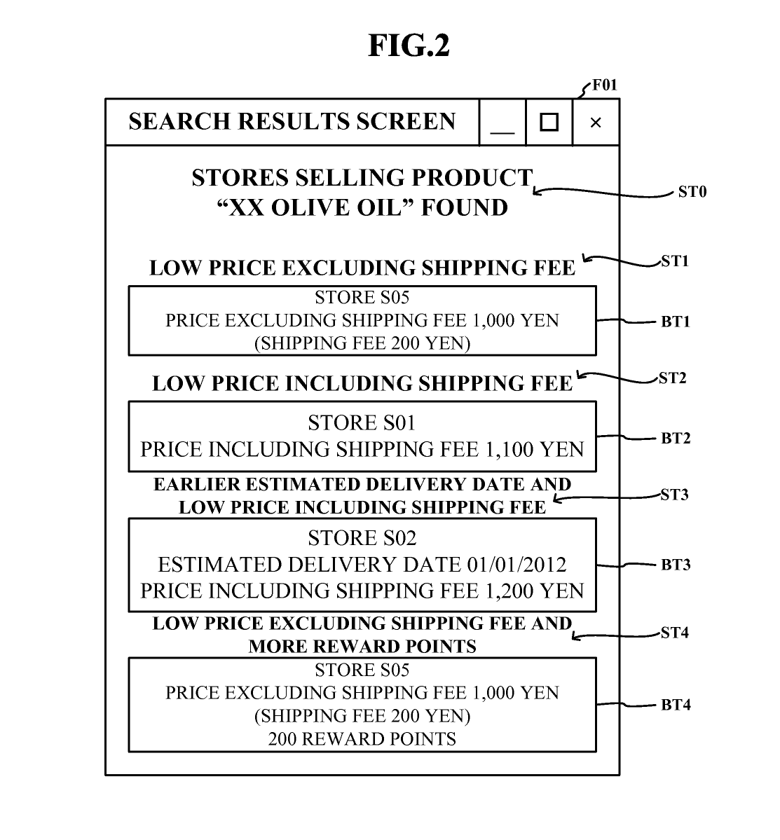

Operated by the user, the inputter 111 of the user terminal 110 enters a keyword for searching a product the user wishes to purchase (the search keyword, hereafter). The user terminal 110 sends information presenting the search keyword (the keyword information, hereafter) to the sales apparatus 200, receives from the sales apparatus 200 information presenting a search results screen F01 as shown in FIG. 2, and displays the search results screen F01 based on the received information using the presenter 112.

The search results screen F01 displays character strings ST1 to ST4 presenting multiple mutually different selection conditions used for selecting stores that sell the product searched for based on the search keyword (the searched product, hereafter). Furthermore, the search results screen F01 displays the character strings ST1 to ST4 presenting multiple selection conditions and buttons BT1 to BT4 presenting the names of stores individually selected using the multiple selection conditions in an associated manner.

The selection conditions individually presented by the character strings ST1 to ST4 are selection conditions for selecting stores individually using different sales conditions. The multiple buttons BT1 to BT4 each display not only the name of a selected store but also the sales mode of the searched products at the selected store.

The user decides with which store he places an order for purchasing the searched product based on the sales mode displayed on the multiple buttons. Subsequently, the user conducts an operation on the inputter 111 of the user terminal 110 to select a button presenting the name of the store to place a purchase order (the order-placed store, hereafter).

The user terminal 110 enters operation information presenting the selected button according to the user operation and sends the entered operation information to the sales apparatus 200.

Subsequently, the sales apparatus 200 receives the operation information from the user terminal 110 and identifies the store having the name displayed on the button presented by the received operation information. Then, the sales apparatus 200 determines that the identified store is the order-placed store with which the user of the user terminal 110 has placed an order for purchasing the searched product. Subsequently, the sales apparatus 200 sends to the order-placed store information presenting the above placement of a purchase order (the purchase order placement information, hereafter).

Here, it is assumed that the store terminals 310 to 360 are used by employees of the stores S01 to S06 and the store S02 is the order-placed store.

The informer 322 of the store terminal 320 displays the event of the user of the user terminal 110 having placed an order for purchasing the searched product with the order-placed store S02 based on the purchase order placement information received from the sales apparatus 200 to inform the employee of the displayed contents. Subsequently, the order-placed store S02 delivers the ordered, searched product to the user of the user terminal 110.

Furthermore, the sales apparatus 200 identifies the selection condition presented by one of the character strings ST1 to ST4 that is associated with the button presented by the operation information (simply the order-placed store selection condition, hereafter).

Here, it is assumed that the stores S01, S02, and S05 are the stores selected using any of the select conditions (the selected stores, hereafter) and posted on the search results screen F01. On the other hand, the stores S03, S04, and S06 are the stores that are not selected based on any of the selection conditions (the eliminated stores, hereafter) and therefore not posted on the search results screen F01.

The sales apparatus 200 sends information presenting the order-placed store selection condition to the store terminals 310, 320, and 350 used by the employees of the selected stores S01, S02, and S05.

The informer 312 of the store terminal 310 and the informer 322 of the store terminal 320 display the order-placed store selection condition based on the information received from the sales apparatus 200 to inform the employees of the displayed contents. Similarly, the store terminal 350 displays the order-placed store selection condition.

The configuration of the sales apparatus 200 selling products based on search keywords will be described in detail hereafter.

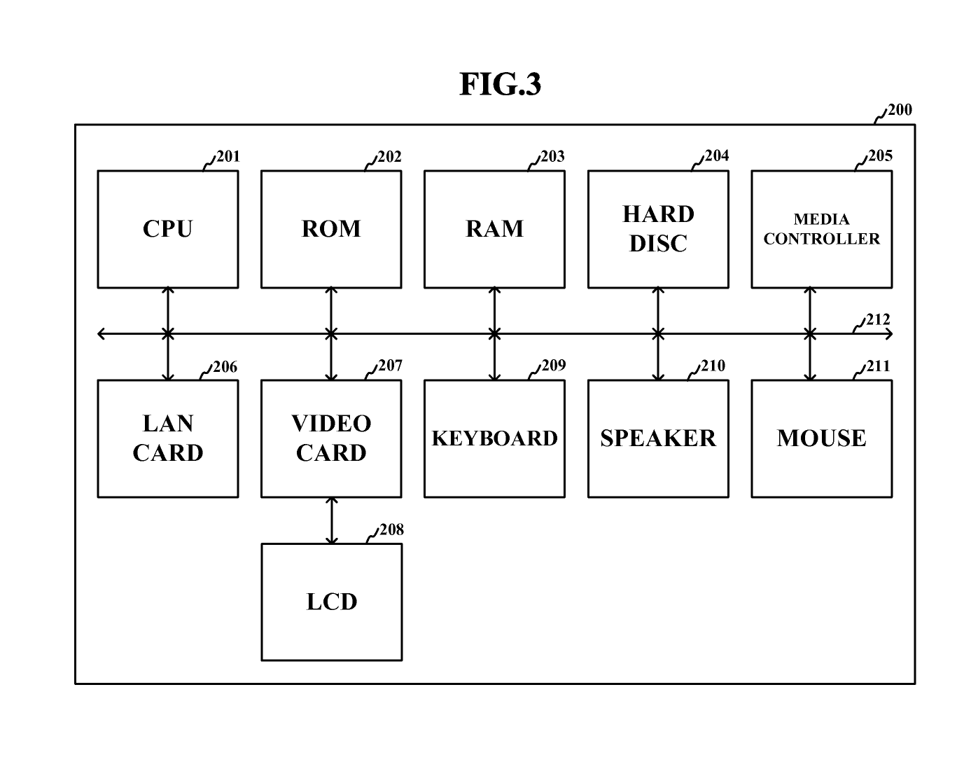

The sales apparatus 200 comprises, as shown in FIG. 3, a CPU (central processing unit) 201, a ROM (read only memory) 202, a RAM (random access memory) 203, a hard disc 204, a media controller 205, a LAN (local area network) card 206, a video card 207, an LCD 208, a keyboard 209, a speaker 210, a mouse 211, and a bus 212 mutually connecting them.

The CPU 201 executes programs stored in the ROM 202 or hard disc 204 to control the entire sales apparatus 200. The RAM 203 temporarily stores data to process while the CPU 201 executes the programs.

The hard disc 204 stores tables in which various data are saved. Incidentally, the sales apparatus 200 can comprise a flash memory in place of the hard disc 204.

The media controller 205 reads various data and programs from non-transitory recording media including flash memory, CDs (compact discs), DVDs (digital versatile discs), and Blue-ray (registered trademark) discs.

The LAN card 206 transmits/receives data to/from the user terminals 110 and 120 and store terminals 310 to 360 connected via the computer communication network 10. The keyboard 209 and mouse 211 enters signals in accordance with the user operation.

The video card 207 draws (namely renders) an image based on digital signals output from the CPU 201, and outputs image signals presenting the rendered image. The LCD 208 displays an image in accordance with the image signals output from the video card 207. Incidentally, the sales apparatus 200 can comprise any of a PDP and EL display in place of the LCD 208. The speaker 210 outputs sound based on signals output from the CPU 201.

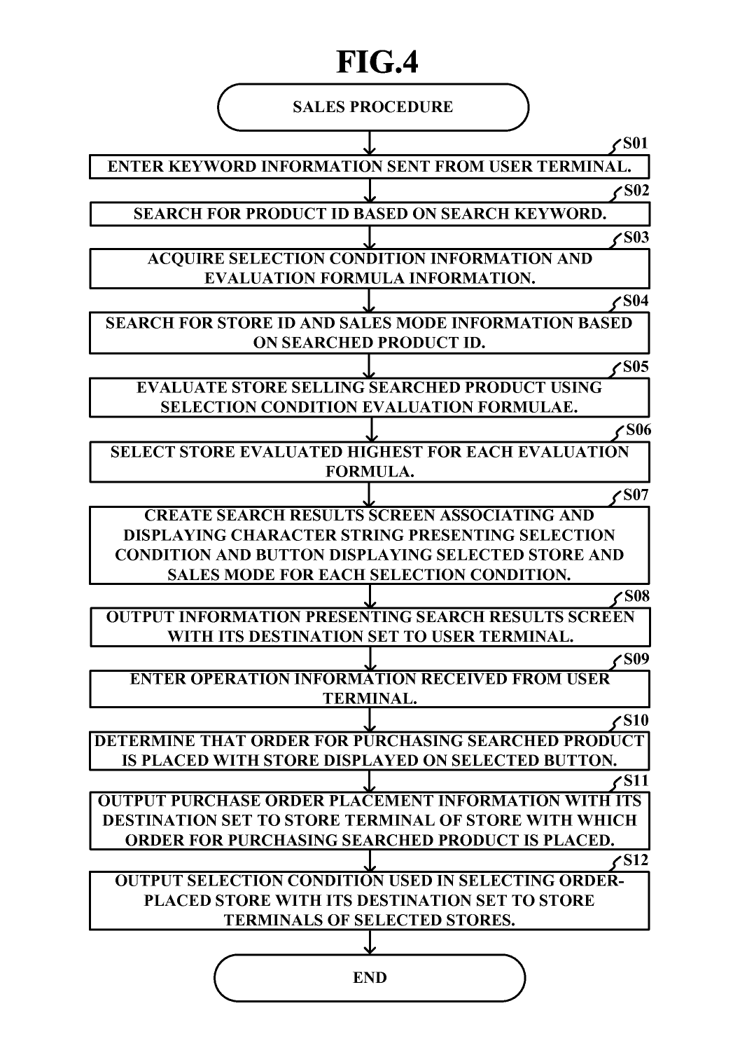

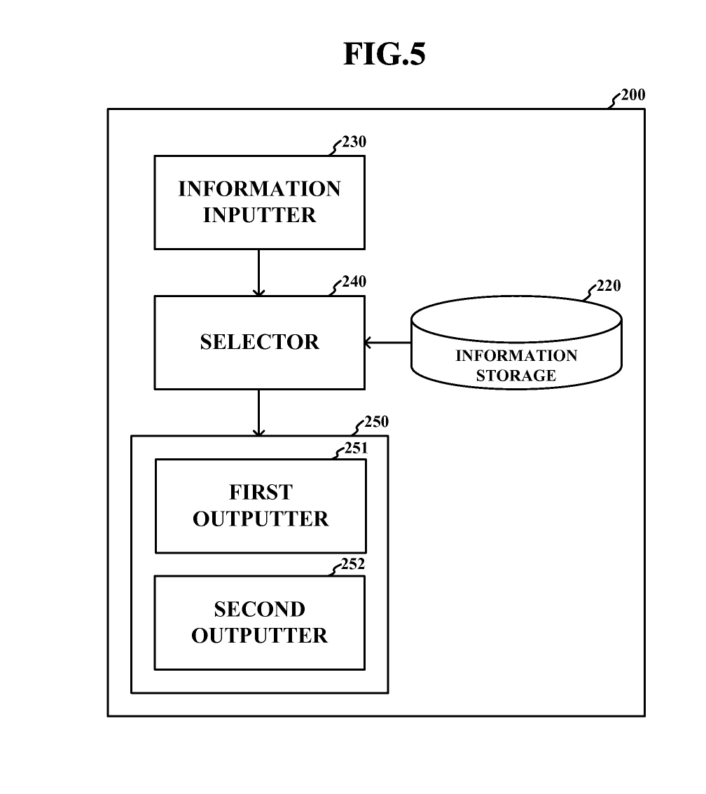

The CPU 201 of the sales apparatus 200 executes the sales procedure in FIG. 4 using the hardware in FIG. 3. As a result, the CPU 201 functions as a selector 240 selecting a store as shown in FIG. 5. Furthermore, the CPU 201 cooperates with the hard disc 204 to function as an information storage 220 storing various kinds of information. Furthermore, the CPU 201 cooperates with the LAN card 206 to function as an information inputter 230 and an information outputter 250 for inputting and outputting information, respectively. The information outputter 250 comprises a first outputter 251 and a second outputter 252.

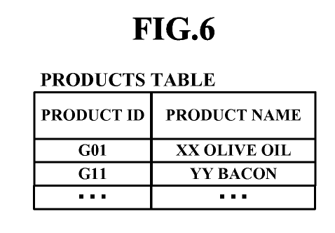

The information storage 220 stores a products table storing information describing the products to sell as shown in FIG. 6. The products table stores multiple records in each of which information identifying a product (the product ID, hereafter) and product name information presenting the name of the product (the product name, hereafter) are associated.

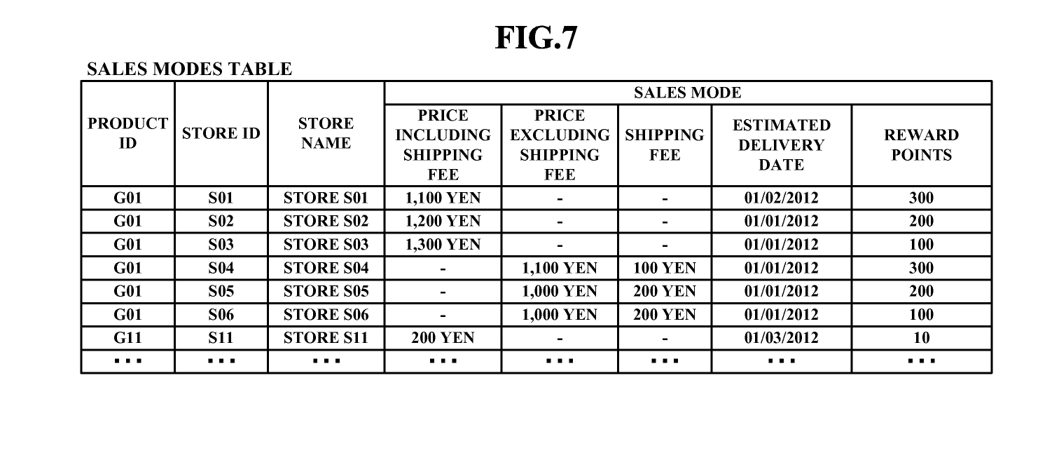

The information storage 220 further stores a sales modes table storing information describing the sales modes of products at the stores as shown in FIG. 7. The sales modes table stores multiple records in each of which the product ID shown in FIG. 6, information identifying a store that sells the product identified by the product ID (the store ID, hereafter), information presenting the store name of the store, and information presenting the sales mode of the product at the store (the sale mode information, hereafter) are associated.

The product sale modes include, for example, a mode of selling a product at a price excluding shipping fee, a mode of selling a product at a price including shipping fee, and a mode of selling a product with an estimated delivery date set to a specific date. Particularly, the mode of selling a product with a set estimated delivery date can be a mode of selling a product with an estimated delivery date set to the date following the system date.

The product sales modes further include a mode of rewarding the purchaser with pseudo money (the points, hereafter) that can be used in compensation for the same or other product or service when a product is sold, and a mode of selling a product individually or in a bundle of two or more pieces.

The product sales modes further include a mode of selling a product that is in stock in a given or larger quantity and a mode of selling a product with a given or more percent discount from the price of the product. The product sales modes further include combinations of the above seven modes.

Therefore, the sales mode information includes information presenting the price including shipping fee of the product identified by the associated product ID, information presenting the price excluding shipping fee of the product, information presenting the shipping fee of the product, information presenting the estimated delivery date of the product, and information presenting the number of points to be granted when the product is sold (the reward points, hereafter).

Incidentally, the information presenting the shipping fee of a product and the information presenting the estimated delivery date of a product can be determined in accordance with the locational relationship between the user and store instead of being determined only by the associated product ID and store ID. Furthermore, the information presenting the estimated delivery date of a product can be updated as the system time goes by.

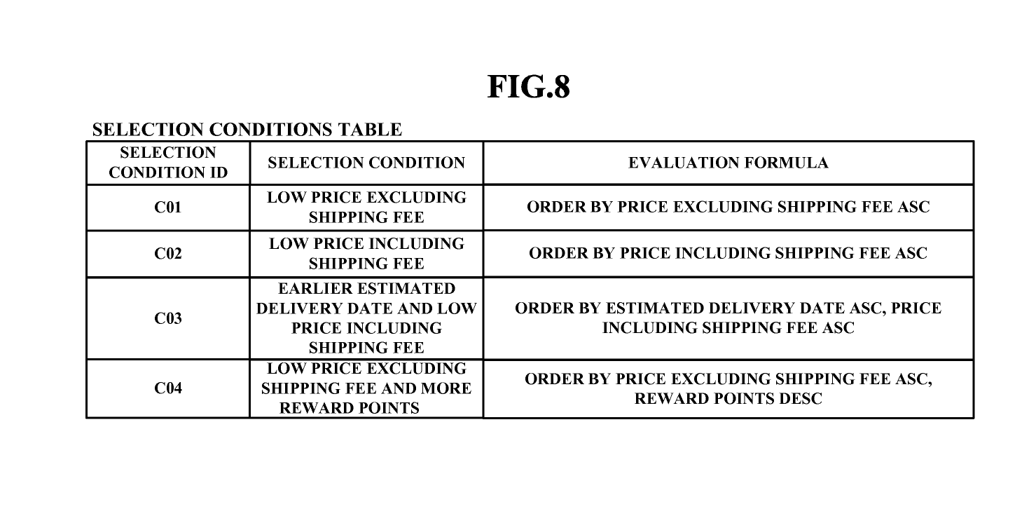

The information storage 220 stores a selection conditions table storing information describing store selection conditions as shown in FIG. 8. The selection conditions table stores multiple records in each of which information identifying a selection condition (the selection condition ID, hereafter), information presenting the selection condition (the selection condition information, hereafter), and information presenting a store evaluation formula using the selection condition (the evaluation formula information, hereafter) are associated.

The explanation will be made on the assumption that the evaluation formula presented by the evaluation formula information is expressed by an SQL ORDER BY command in this embodiment.

The selection condition identified by a selection condition ID “C01” is a condition used for selecting a store that offers a “LOW PRICE EXCLUDING SHIPPING FEE”.

Here, the method of evaluating the stores selling the product having a product ID “G01” using the selection condition having the selection condition ID “C01” will be described hereafter.

Multiple records storing the store ID of a store selling the product identified by the product ID “G01” among the records stored in the sales modes table in FIG. 7 are searched for using an SQL “SELECT*FROM SALES MODES TABLE WHERE PRODUCT ID=‘G01’”.

The records found using the above SQL are sorted in the ascending order of the values stored in the column “PRICE EXCLUDING SHIPPING FEE”, whereby the records are arranged in the order from the record storing the store ID of a store ranked highest according to the evaluation formula of the selection condition of the selection condition ID “C01”.

The SQL command for sorting in the ascending order of the values stored in the column “PRICE EXCLUDING SHIPPING FEE” is “ORDER BY PRICE EXCLUDING SHIPPING FEE ASC”. The evaluation formula for the selection condition having the selection condition ID “C01” is expressed by the above ORDER BY command.

Similarly, the selection condition identified by a selection condition ID “C02” is used to select a store that offers a “LOW PRICE INCLUDING SHIPPING FEE”. Therefore, the evaluation formula for this condition is expressed by an SQL ORDER BY command “ORDER BY PRICE INCLUDING SHIPPING FEE ASC”.

Furthermore, the selection condition identified by a selection condition ID “C03” is used to select a store that offers an “EARLIER ESTIMATED DELIVERY DATE AND LOW PRICE INCLUDING SHIPPING FEE”. In the ranking according to this condition, if stores have the same estimated delivery date, the store offering a lower price including shipping is ranked higher. Therefore, the evaluation formula for this condition is expressed by an SQL ORDER BY command “ORDER BY ESTIMATED DELIVERY DATE ASC, PRICE INCLUDING SHIPPING FEE ASC”.

Furthermore, the selection condition identified by a selection condition ID “C04” is used to select a store that offers a “LOW PRICE EXCLUDING SHIPPING FEE AND MORE POINTS”. In the ranking according to this condition, if stores set the same price excluding shipping fee, the store offering more points is ranked higher. Therefore, the evaluation formula for this condition is expressed by an SQL ORDER BY command “ORDER BY PRICE EXCLUDING SHIPPING FEE ASC, REWARD POINTS DESC”.

The sales procedure in FIG. 4 that is executed using the above tables stored by the information storage 220 will be described hereafter.

As the LAN card 206 shown in FIG. 3 receives information presenting a search keyword from the user terminal 110, the sales apparatus 200 starts to execute the sales procedure.

Here, the explanation will be made on the assumption that the user of the user terminal 110 enters “XX OLIVE OIL” as a search keyword and the LAN card 206 receives keyword information presenting “XX OLIVE OIL” from the user terminal 110.

First, the information inputter 230 shown in FIG. 5 enters keyword information presenting the search keyword “XX OLIVE OIL” from the LAN card 206 (Step S01).

Then, the selector 240 searches the products table shown in FIG. 6 and acquires a product ID “G01” associated with information presenting a product name identical to the search keyword “XX OLIVE OIL” presented by the keyword information entered by the information inputter 230 (Step S02).

Then, the selector 240 acquires multiple records each storing selection condition information and evaluation formula information from the selection conditions table shown in FIG. 8 (Step S03). As a result of this processing, the selector 240 acquires four records each storing selection condition information and evaluation formula information of a selection condition identified by the selection condition IDs “C01”, “C02”, “C03”, and “C04”.

Then, the selector 240 searches the sales modes table shown in FIG. 7 and acquires the records storing the store ID and sales mode information associated with a product ID identical to the searched product ID “G01” (the searched product ID, hereafter) (Step S04).

Subsequently, the selector 240 evaluates the stores selling the searched product identified by the product ID “G01” searched for in the Step S02 on the basis of evaluation formula presented by the evaluation formula information searched for in the step S04 (Step S05).

More specifically, in the processing of the Steps S04 and S05, the selector 240 creates an SQL code to use in searching the sales modes table in FIG. 7 for the records in which the product ID “G01” is stored (the basic SQL code, hereafter). The basic SQL code is, for example, “SELECT * FROM SALES MODES TABLE WHERE PRODUCT ID=‘G01’”.

Then, the selector 240 creates an SQL code by adding to the basic SQL an ORDER BY command “ORDER BY PRICE EXCLUDING SHIPPING FEE ASC” presenting the evaluation formula for the selection condition having the selection condition ID “C01” (the evaluation SQL for the selection condition ID “C01”, hereafter). Similarly, the selector 240 creates an evaluation SQL for the selection condition ID “C02”, an evaluation SQL for the selection condition ID “C03”, and an evaluation SQL for the selection condition ID “C04”.

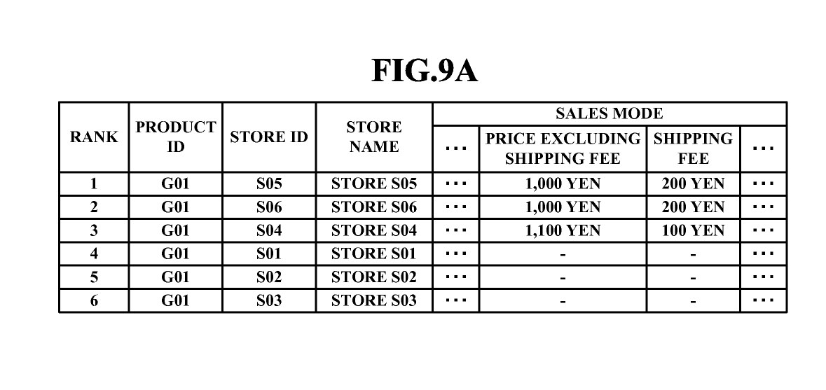

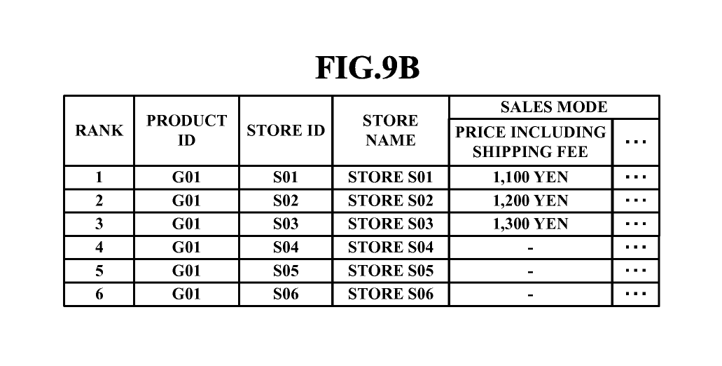

Subsequently, using the evaluation SQL for the selection condition ID “C01”, the selector 240 creates a table as shown in FIG. 9A (the evaluation table for the selection condition ID “C01”, hereafter). In the evaluation table for the selection condition ID “C01”, the records storing the store IDs “S05”, “S06”, and “S04”, respectively, are arranged in this order from the top. This is because the selection condition having the selection condition ID “C01” is the condition for selecting a store offering a “LOW PRICE EXCLUDING SHIPPING FEE”.

Incidentally, in the evaluation table for the selection condition ID “C01”, the record storing the store ID “S06” can be ranked higher than the record storing the store ID “S05”. This is because the store having the store ID “S05” and the store having the store ID “S06” sell the product having the product ID “G01” at the same price excluding shipping fee “1,000 yen”. Furthermore, the three records storing the store IDs “S01” to “S03” can be arranged in any order because the stores having the store IDs “S01” to “S03” do not sell the searched product at a price excluding shipping fee.

Similarly, using the evaluation SQL for the selection condition ID “C02”, the selector 240 creates a table as shown in FIG. 9B (the evaluation table for the selection condition ID “C02”, hereafter). In the evaluation table for the selection condition ID “C02”, the records storing the store IDs “S01”, “S02”, and “S03”, respectively, are arranged in this order from the top. This is because the selection condition having the selection condition ID “C02” is the condition for selecting a store offering a “LOW PRICE INCLUDING SHIPPING FEE”.

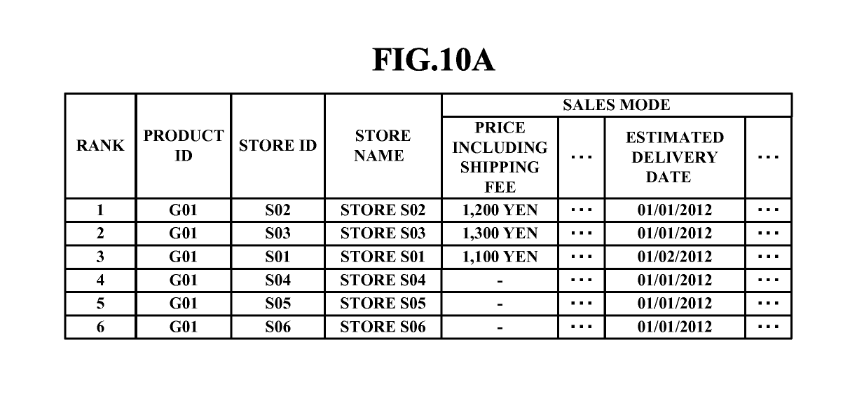

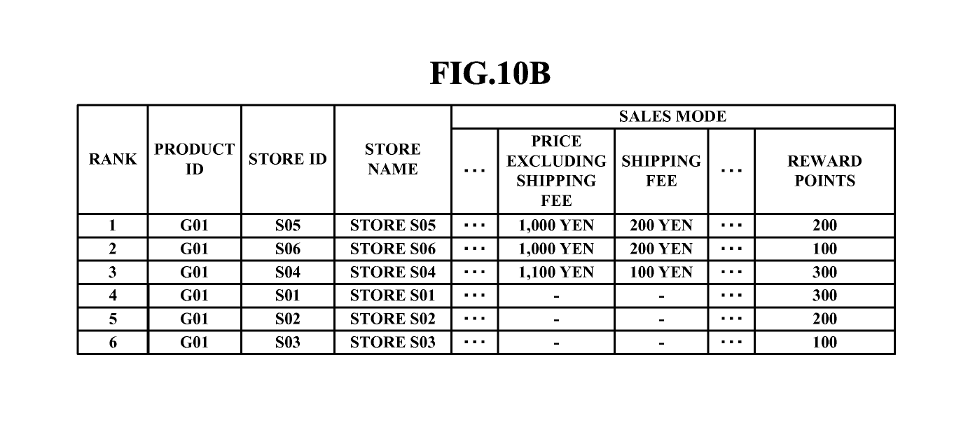

Furthermore, using the evaluation SQL for the selection condition ID “C03”, the selector 240 creates a table as shown in FIG. 10A (the evaluation table for the selection condition ID “C03”, hereafter). In the evaluation table for the selection condition ID “C03”, the records storing the store IDs “S02”, “S03”, and “S01”, respectively, are arranged in this order from the top. This is because the selection condition having the selection condition ID “C03” is the condition for selecting a store offering an “EARLIER ESTIMATED DELIVERY DATE AND LOW PRICE INCLUDING SHIPPING FEE”.

In other words, the store having the store ID “S02” and the store having the store ID “S03” have higher evaluation scores than the store having the store ID “S01”. This is because the store having the store ID “S02” and the store having the store ID “S03” have an estimated delivery date “Jan. 1, 2012”, which is earlier than the estimated delivery date “Jan. 2, 2012” of the store having the store ID “S01”. Furthermore, the store having the store ID “S02” has a higher evaluation score than the store having the store ID “S03”. This is because the store having the store ID “S02” offers a price including sipping fee “1,200 yen”, which is lower than the price including sipping fee “1,300 yen” of the store having the store ID “S03”.

Furthermore, using the evaluation SQL for the selection condition ID “C04”, the selector 240 creates a table as shown in FIG. 10B (the evaluation table for the selection condition ID “C04”, hereafter). In the evaluation table for the selection condition ID “C04”, the records storing the store IDs “S05”, “S06”, and “S04”, respectively, are arranged in this order from the top. This is because the selection condition having the selection condition ID “C04” is the condition for selecting a store offering a “LOW PRICE EXCLUDING SHIPPING FEE AND MORE REWARD POINTS”.

In other words, the store having the store ID “S05” and the store having the store ID “S06” have higher evaluation scores than the store having the store ID “S04”. This is because the store having the store ID “S05” and the store having the store ID “S06” offer a price excluding shipping fee “1,000 yen”, which is lower than the price excluding shipping fee “1,100 yen” of the store having the store ID “S04”. Furthermore, the store having the store ID “S05” has a higher evaluation score than the store having the store ID “S06”. This is because the store having the store ID “S05” grants “200” reward points, which is more than “100” reward points by the store having the store ID “S06”.

Then, the selector 240 selects one store evaluated highest in the Step S05 for each of the evaluation formulae presented by the evaluation formula information acquired in the Step S03 in FIG. 4 (Step S06).

In other words, in regard to the selection condition having the selection condition ID “C01”, the selector 240 selects the store S05 identified by the store ID “S05” stored in the first record of the evaluation table for the selection condition ID “C01”. Similarly, the selector 240 selects the store S01 of the store ID “S01” stored in the first record of the evaluation table for the selection condition ID “C02”, the store S02 of the store ID “S02” stored in the first record of the evaluation table for the selection condition ID “C03”, and the store S05 of the store ID “S05” stored in the first record of the evaluation table for the selection condition ID “C04”.

Then, the selector 240 creates a search results screen F01 as shown in FIG. 2 on which a character string ST0 presenting the product name “XX OLIVE OIL” of the product ID “G01” searched for in the Step S02 is displayed. Then, the selector 240 adds to the search results screen F01 character strings ST1 to ST4 to presenting the selection conditions identified by the selection condition IDs “C01” to “C04”, respectively.

Furthermore, the selector 240 searches the evaluation tables for the selection condition IDs “C01” to “C04” and acquires information presenting the store names of the stores selected using the selection conditions presented by their respective character strings ST1 to ST4 (namely, the selected stores) and information presenting the sales modes of the selected stores.

Then, the selector 240 creates information presenting buttons BT1 to BT4 displaying the store names of the selected stores selected using the selection conditions presented by their respective character strings ST1 to ST4 and the sales modes used in selecting the selected stores. Subsequently, the selector 240 adds the buttons BT1 to BT4 under the character strings ST1 to ST4 on the search results screen F01 (Step S07).

Displayed on the added button BT1 is a character string indicating that the selected store selected with the selection condition “LOW PRICE EXCLUDING SHIPPING FEE” is the store S05 identified by the store ID “S05”. Further displayed on the button BT1 is a character string indicating that the store S05 sells the searched product “XX OLIVE OIL” in the sales mode that the price excluding shipping fee is “1,000 yen” and the shipping is fee “200 yen”.

Similarly, displayed on the button BT2 is indication that the selected store selected with the selection condition “LOW PRICE INCLUDING SHIPPING FEE” is the store S01 and the store S01 sells the searched product in the sales mode that the price including shipping fee is “1,100 yen”.

Furthermore, displayed on the button BT3 is indication that the selected store selected with the selection condition “EARLIER ESTIMATED DELIVERY DATE AND LOW PRICE INCLUDING SHIPPING FEE” is the store S02. Further displayed on the button BT3 is indication that the store S02 sells the searched product in the sales mode that the estimated delivery date of the searched product is “Jan. 1, 2012” and the price including shipping fee is “1,200 yen”.

Furthermore, displayed on the button BT4 is indication that the selected store selected with the selection condition “LOW PRICE EXCLUDING SHIPPING FEE AND MORE REWARD POINTS” is the store S05. Further displayed on the button BT4 is indication that the store S05 sells the searched product in the sales mode that the price excluding shipping fee is “1,000 yen”, the shipping fee is “200 yen”, and “200” points are granted to the purchaser.

Incidentally, the selector 240 sets button IDs “B01” to “B04” for the buttons BT1 to BT4 to identify the buttons.

Furthermore, the selector 240 associates and stores the button ID “B01”, the store ID “S05” of the store S05 displayed by the button BT1, the selection condition ID “C01” of the selection condition used in selecting the store S05, and the searched product ID “G01” in the information storage 220.

Similarly, the selector 240 associates and stores the button ID “B02”, the store ID “S01”, the selection condition ID “C02”, and the searched product ID “G01”, and associates and stores the button ID “B03”, the store ID “S02”, the selection condition ID “C03”, and the searched product ID “G01”. Similarly, the selector 240 associates and stores the button ID “B04”, the store ID “S05”, the selection condition ID “C04”, and the searched product ID “G01”. This is for making it possible at later times to identify the button selected by the user, the product name displayed on the selected button, the selection condition displayed in association with the selected button, and the like.

The first outputter 251 shown in FIG. 5 outputs to the LAN card 206 shown in FIG. 3 information presenting the search results screen F01 created in the Step S07 with its destination set to the user terminal 110 (Step S08). Subsequently, the LAN card 206 sends the information presenting the search results screen F01 to the user terminal 110.

Subsequently, the user terminal 110 receives the information from the sales apparatus 200, and displays the search results screen F01 shown in FIG. 2 on the presenter 112 based on the received information.

Here, the explanation is made on the assumption that the user of the user terminal 110 has a first interest in acquiring the searched product by “Jan. 2, 2012”. It is further assumed that the user has a second interest, which has lower priority than the first interest, in acquiring the searched product at a price lower than other stores. Incidentally, this user has no intention of using points; therefore, whether more points are granted upon purchase of the searched product does not matter to the user's interest.

The user cannot know when he can acquire the searched product based on the sales modes displayed on the buttons BT1 and BT4. However, the user can know that he can acquire the searched product at a total amount of “1,200 yen”, the price excluding shipping fee “1,000 yen” plus the shipping fee “200 yen”, from the store S05.

Furthermore, the user cannot know when he can acquire the searched product based on the sales mode displayed on the button BT2. However, the user can know that he can acquire the searched product at a price including shipping fee “1,100 yen” from the store S01.

Therefore, the user judges that the sale mode of the store S01 is more suitable for the user's interest than the sales mode of the store S05. This is because the total amount the user pays to the store S01 for acquiring the searched product is lower than to the store S05.

Furthermore, the user judges that the user can acquire the searched product at a price excluding shipping fee “1,200 yen” on “Jan. 1, 2012” from the store S02 based on the sales mode displayed on the button BT3.

Therefore, the user judges that the sales mode of the store S02 is more suitable for the user's interest than the sales mode of the store S01, and conducts an operation on the user terminal 110 to select the button BT3 displaying the name of the store S02. This is because the first interest in acquiring the searched product by “Jan. 2, 2012” has higher priority than the second interest in acquiring the searched product at a price lower than other stores.

According to the user operation, the user terminal 110 sends the button ID “B03” of the selected button BT3 to the sales apparatus 200 as operation information presenting the button BT3.

Subsequently, the LAN card 206 of the sales apparatus 200 receives the operation information “B03” from the user terminal 110. Then, the information inputter 230 enters the operation information “B03” from the LAN card 206 (Step S09).

Subsequently, the selector 240 searches and acquires the store ID “S02” and product ID “G01” stored in the information storage 220 in association with the operation information “B03”. This is for identifying the store displayed on the button BT3 presented by the operation information “B03”. Then, the selector 240 determines that the user of the user terminal 110 has placed an order for purchasing the searched product identified by the product ID “G01” with the store S02 identified by the store ID “S02” (Step S10).

Subsequently, the second outputter 252 outputs to the LAN card 206 shown in FIG. 3 purchase order placement information presenting placement of a purchase order determined in the Step S10 with its destination set to the store terminal 320 used by the employee of the store S02 (Step S11). Subsequently, the LAN card 206 sends the purchase order placement information to the store terminal 320.

Receiving the purchase order placement information, the store terminal 320 displays on the informer 322 shown in FIG. 1 the event of the user of the user terminal 110 having placed an order for purchasing the searched product identified by the product ID “G01”.

Then, the selector 240 of the sales apparatus 200 searches and acquires the selection condition ID “C03” stored in the information storage 220 in association with the operation information “B03”. Then, the selector 240 searches the selection conditions table in FIG. 8 and acquires the selection condition information associated with the acquired selection condition ID “C03”. This is for identifying the selection condition associated with the button BT3 presented by the operation information “B03”.

Subsequently, the selector 240 identifies the acquired selection condition information as information presenting the selection condition used in selecting the store S02 with which the purchase order has been placed (namely the selection condition of the order-placed store S02).

Subsequently, the selector 240 searches and acquires the store IDs “S01”, “S02”, and “S05” of the selected stores stored in the information storage 220 in association with the selection condition IDs “C01” to “C04”.

Subsequently, the second outputter 252 designates the store terminals 310, 320, and 350 used by the employees of the selected stores S01, S02, and S05 as the destination and outputs to the LAN card 206 shown in FIG. 3 information presenting the selection condition of the order-placed store S02 (Step S12). The LAN card 206 sends the information presenting the selection condition of the order-placed store S02 to the store terminals 310, 320, and 350. Subsequently, the second outputter 252 ends the sales procedure.

Receiving the above information from the sales apparatus 200, the store terminals 310 and 320 each displays the selection condition of the order-placed store S02 on the informers 312 and 322 shown in FIG. 1. The store terminal 350 similarly displays the selection condition of the order-placed store S02.

With the above configuration, the sales system 1 presents to the user multiple buttons displaying multiple stores and their product sales modes selected separately using multiple selection conditions. Therefore, the sales system 1 can present the stores selling the product in the sales modes suitable for the user's interest. Furthermore, the user can easily know the store selling the product in the sales mode suitable for the user's interest.

Furthermore, with the above configuration, as the operation information presenting the button operated by the user is entered, the sales system 1 informs the store selling the product in the sales mode associated with the operated button that an order is placed for purchasing the product. Therefore, the user can easily place a purchase order with the store selling the product in the sales mode suitable for the user's interest by simply operating the button.

Furthermore, with the above configuration, the sales system 1 can urge the stores to compete in sales using a variety of sales modes instead of using a single sales mode such as selling at a low price.

Furthermore, with the above configuration, the sales system 1 informs multiple stores selected using different selection conditions of the selection condition used in selecting the store associated with the button operated by the user. Therefore, the sales system 1 can inform multiple selected stores that what selection condition is used in selecting the store with which an order for purchasing the product is placed. Furthermore, the sales system 1 can urge the employees of the selected stores to change the sales modes of the product according to the informed selection condition so that the product is more likely to be selected.

### Modified Embodiment 1

In the embodiment, the selector 240 of the sales apparatus 200 shown in FIG. 5 selects one store having the highest evaluation score for each of the selection condition evaluation formulae in the Step S06 of the sales procedure shown in FIG. 4. Furthermore, the selector 240 creates the search results screen F01 displaying one button presenting the name of one selected store in association with one selection condition as shown in FIG. 2 in the Step S07.

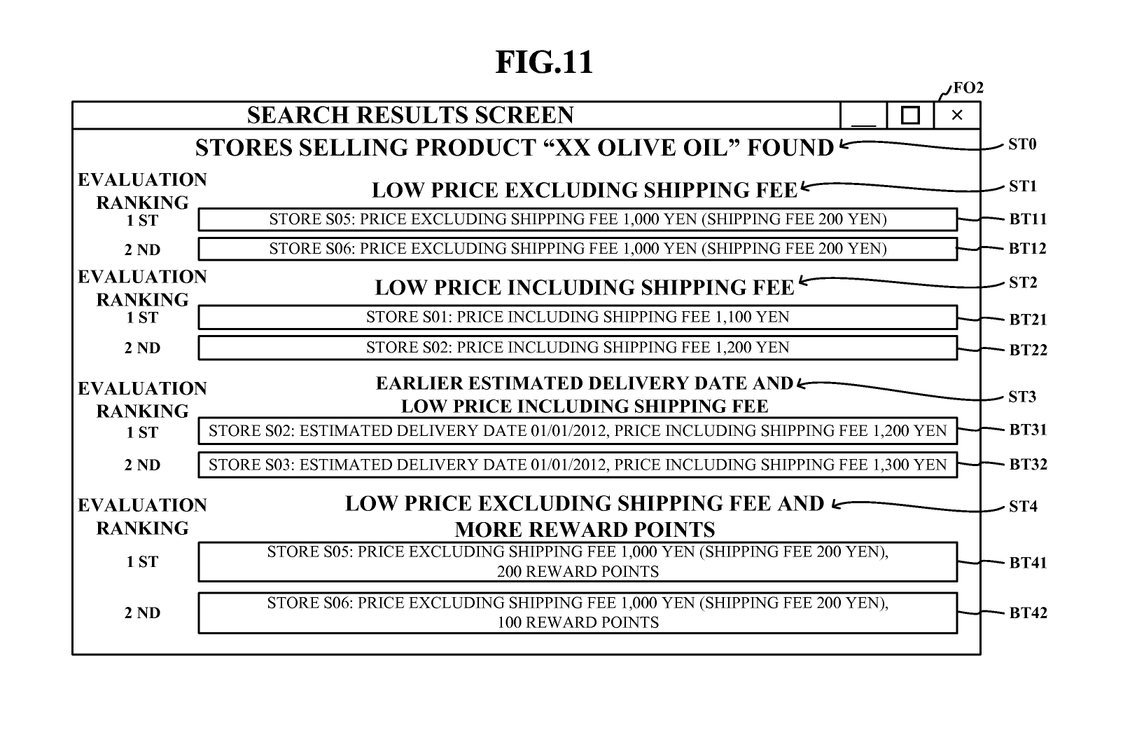

In this modified embodiment, the selector 240 selects two stores having the highest and second highest evaluation scores for each of the selection condition evaluation formulae in the Step S06. Furthermore, the selector 240 creates a search results screen F02 displaying, as shown in FIG. 11, two buttons presenting the evaluation rank of one selected store, and the name of the selected store, and the sales mode of the selected store in association with one selection condition.

More specifically, the selector 240 adds a character string ST1 presenting the selection condition “LOW PRICE EXCLUDING SHIPPING FEE” presented by the selection condition ID “C01” on the search results screen F02. Furthermore, the selector 240 creates a button BT11 displaying the store name “STORE S05” of the store associated with the first place of the evaluation ranking in the evaluation table for the selection condition ID “C01” shown in FIG. 9A. Then, the selector 240 displays on the created button BT11 the sales mode “PRICE EXCLUDING SHIPPING FEE 1,000 YEN (SHIPPING FEE 200 YEN)” used in selecting the store S05 in association with the store name “STORE S05”. Subsequently, the selector 240 adds the button BT11 immediately below the character string ST1.

Furthermore, the selector 240 adds immediately below the button BT11 a button BT12 associating and displaying the store name STORE S06 of the store associated with the second place of the evaluation ranking in the evaluation table for the selection condition ID “C01” and the sales mode “PRICE EXCLUDING SHIPPING 1,000 YEN (SHIPPING FEE 200 YEN)” used in selecting the store S06.

Similarly, the selector 240 adds a character string ST2 presenting the selection condition presented by the selection condition ID “C02” on the search results screen F02. Furthermore, the selector 240 adds immediately below the character string ST2 a button BT21 associating and displaying the store name of the store associated with the first place of the evaluation ranking in the evaluation table for the selection condition ID “C02” shown in FIG. 9B and the sales mode used in selecting the store. Furthermore, the selector 240 adds immediately below the button BT21 a button BT22 associating and displaying the store name of the store associated with the second place of the evaluation ranking in the evaluation table for the selection condition ID “C02” and the sales mode used in selecting the store.

Furthermore, the selector 240 adds a character string ST3 presenting the selection condition of the selection condition ID “C03” and buttons BT31 and BT32 displaying the store names and sales modes associated with the first and second places of the evaluation ranking in the evaluation table for the selection condition ID “C03” shown in FIG. 10A on the search results screen F02 in sequence from the upper part.

Similarly, the selector 240 adds a character string ST4 presenting the selection condition of the selection condition ID “C04” and buttons BT41 and BT42 displaying the store names and sales modes associated with the first and second places of the evaluation ranking in the table shown in FIG. 10B on the search results screen F02 in sequence from the upper part.

Incidentally, the selector 240 can select top three or more stores in the evaluation score ranking for each of the selection condition evaluation formulae. Furthermore, the selector 240 can associate three or more buttons presenting the evaluation rank of one selected store, the names of the selected store, and the sales modes of the selected store with one selection condition.

With the above configuration, the sales system 1 according to Modified Embodiment 1 presents to the user of the user terminal 110 the search results screen F02 associating multiple buttons presenting the names of the selected stores and the sales modes of the selected stores with one selection condition. Therefore, the sales system 1 according to Modified Embodiment 1 can present the store selling the product in the sales mode more suitable for the user's interest than in the embodiment.

### Modified Embodiment 2

In Modified Embodiment 1 of the embodiment, the selector 240 of the sales apparatus 200 shown in FIG. 5 creates the search results screen F02 as shown in FIG. 11 in the Step S07 of the sales procedure shown in FIG. 4. The search results screen F02 displays two buttons presenting the name of one selected store and the sales mode of the selected store in association with one selection condition.

Furthermore, in Modified Embodiment 1 of the embodiment, the user of the user terminal 110 conducts an operation on the user terminal 110 to select a button on which the name of the store to place an order for purchasing the product is displayed among the buttons displayed on the search results screen F02.

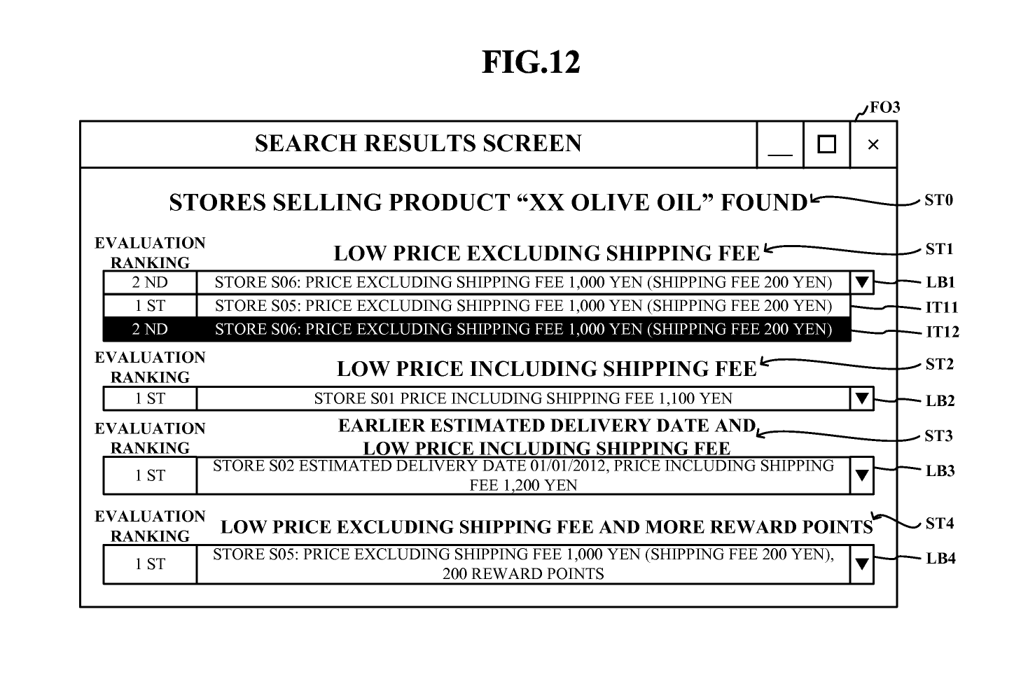

In this modified embodiment, the selector 240 creates a search results screen F03 on which one selection condition is associated with one list box displaying two items presenting the name of one selected store and the sales mode of the selected store as shown in FIG. 12 in the Step S07.

More specifically, the selector 240 adds a character string ST1 presenting the selection condition “LOW PRICE EXCLUDING SHIPPING FEE” presented by the selection condition ID “C01” to the search results screen F03. Then, the selector 240 creates an item IT11 associating and displaying the store name “STORE S05” of the store associated with the first place of the evaluation ranking in the evaluation table for the selection condition ID “C01” shown in FIG. 9A and the sales mode “PRICE EXCLUDING SHIPPING FEE 1,000 YEN (SHIPPING FEE 200 YEN)” used in selecting the store S05. Furthermore, the selector 240 creates an item IT12 associating and displaying the store name STORE S06 of the store associated with the second place of the evaluation ranking in the evaluation table for the selection condition ID “C01” and the sales mode “PRICE EXCLUDING SHIPPING FEE 1,000 YEN (SHIPPING FEE 200 YEN)” used in selecting the store S06. Subsequently, the selector 240 creates a list box LB1 displaying the items IT11 and IT12 and adds the list box LB1 immediately below the character string ST1.

Similarly, the selector 240 creates character strings ST2 to ST4 presenting the selection conditions of the selection condition IDs “C02”, “C03”, and “C04”, respectively. Then, the selector 240 creates two items displaying the names of the stores at the first and second places of the evaluation ranking in each of the evaluation tables for the selection condition IDs “C02”, “C03”, and “C04” shown in FIGS. 9B, 10A, and 10B. Subsequently, the selector 240 creates list boxes LB2 to LB4 each having two items for each of the selection condition IDs “C02”, “C03”, and “C04”. The selector 240 adds the character string ST2, list box LB2, character string ST3, list box LB3, character string ST4, and list box LB4 on the search results screen F03 in this order from the upper part.

In this modified embodiment, the user of the user terminal 110 can choose from the items IT11 and IT12 of the list box LB1 and from two items of each of the list boxes LB2 to LB4 displayed on the search results screen F03. Furthermore, the user of the user terminal 110 conducts an operation on the user terminal 110 to select one among the above eight items.

However, this is not restrictive. The items to choose displayed on the search results screen F03 can be check boxes or radio buttons. Any kind of objects that generate an event presenting the operation in accordance with the user selection operation can be used.

### Modified Embodiment 3

In the embodiment, the selector 240 of the sales apparatus 200 shown in FIG. 5 creates the search results screen F02 as shown in FIG. 2 in the Step S07 of the sales procedure shown in FIG. 4. The search results screen F02 displays one button presenting the name of one selected store and the sales mode of the selected store in association with one selection condition.

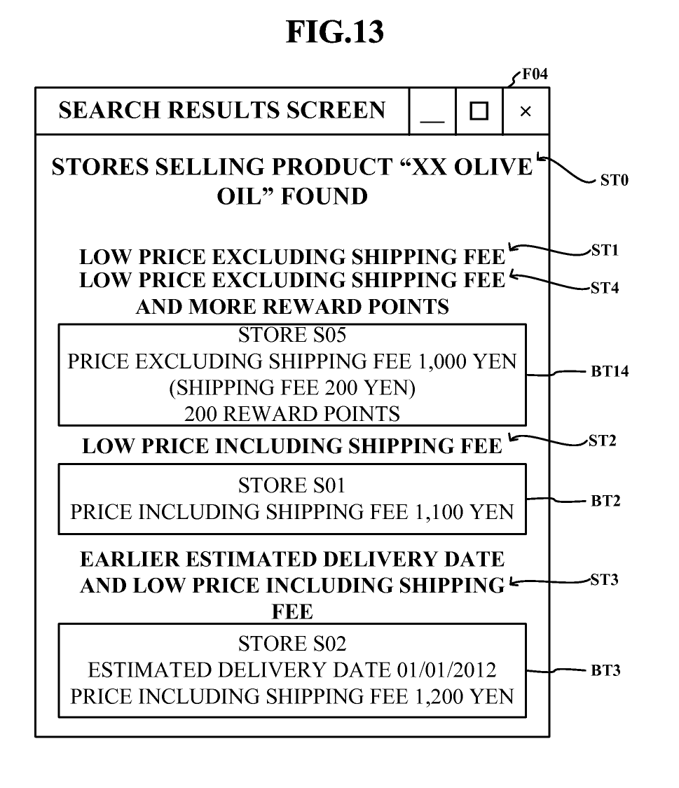

In this modified embodiment, the selector 240 creates a search results screen F04 displaying one button presenting the name of one selected store and the sales mode of the selected store in association with one or multiple selection conditions used in selecting the selected store as shown in FIG. 13 in the Step S07.

More specifically, the selector 240 adds a character string ST1 presenting the selection condition “LOW PRICE EXCLUDING SHIPPING FEE” presented by the selection condition ID “C01” to the search results screen F04.

Then, the selector 240 identifies the store S05 as the store selected using the selection condition presented by the selection condition ID “C01” based on the selection results for the selected store in the Step S06. Then, the selector 240 determines that there is another selection condition used in selecting the store S05 besides the selection condition ID “C01”. Subsequently, the selector 240 identifies the selection condition “EARLIER ESTIMATED DELIVERY DATE AND LOW PRICE INCLUDING SHIPPING FEE” identified by the selection condition ID “C04” as the selection condition other than the selection condition ID “C01” (the other selection condition, hereafter), and adds a character string ST4 presenting the identified selection condition immediately below the character strung ST1.

Subsequently, the selector 240 creates a character string presenting both the sales mode of the store S05 used under the selection condition of the selection condition ID “C01” for selecting the store S05 and the sales mode of the store S05 used under the selection condition of the selection condition ID “C04”.

Then, the selector 240 adds a button BT14 displaying the character string presenting the two sales modes “PRICE EXCLUDING SHIPPING FEE 1,000 YEN (SHIPPING FEE 200 YEN) 200 REWARD POINTS” immediately below the character strings ST1 and ST4.

Then, the selector 240 adds a character string presenting the selection condition “LOW PRICE INCLUDING SHIPPING FEE” presented by the selection condition ID “C02” to the search results screen F04.

Then, the selector 240 determines that the store selected using the selection condition presented by the selection condition ID “C02” is the store S01 and there is no other selection condition used in selecting the store S01 and identified by any ID different from the selection condition ID “C02”.

Subsequently, the selector 240 adds a button BT2 presenting the sales mode of the store S01 used in selecting the store S01 under the selection condition of the selection condition ID “C02” immediately below the character string ST2.

Similarly, the selector 240 adds a button BT3 presenting the sales mode of the store S02 used in selecting the store S02 under the selection condition of the selection condition ID “C03” immediately below the character string ST3.

With the above configuration, the sales system 1 displays one button presenting one selected store and the sales mode of the store in association with multiple selection conditions when one and the same store is selected under multiple selection conditions. Therefore, the user can more easily know the store selling the product in the sales mode suitable for the user's interest than in the embodiment.

### Modified Embodiment 4

In the embodiment, the sales apparatus 200 sends information presenting the selection condition used in selecting the store with which the purchase order is placed (namely the order-placed store selection condition) to the selected stores selected using any of the different selection conditions. Furthermore, the sales apparatus 200 does not send the information presenting the selection condition to the eliminated stores that were not selected using any of the different selection conditions.

In this modified embodiment, the sales apparatus 200 sends information presenting the evaluation ranks of eliminated stores in evaluation under the selection condition used in selecting the order-placed store to the store terminals used by the eliminated stores.

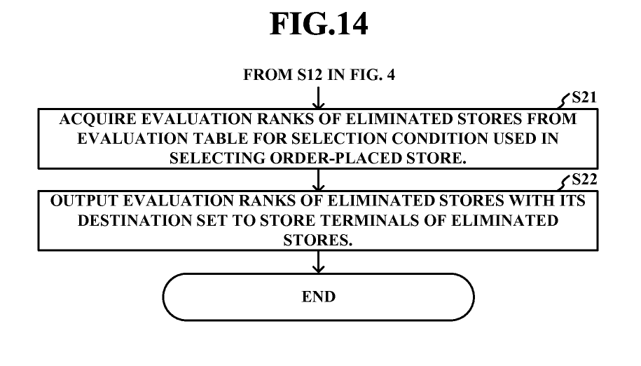

More specifically, after executing the Steps S01 to S12 of the sales procedure shown in FIG. 4, the sales apparatus 200 executes Step S21 shown in FIG. 14 instead of ending the sales procedure.

In the Step S21, the selector 240 of the sales apparatus 200 shown in FIG. 5 identifies the store IDs “S03”, “S04”, and “S06” of the eliminated stores S03, S04, and S06 that were not selected in the Step S06 in FIG. 4. Then, the selector 240 identifies the selection condition ID “C03” identifying the selection condition for the purchase store with which the purchase order is placed in the Step S10. Subsequently, the selector 240 searches the evaluation table for the selection condition ID “C03” shown in FIG. 10A and acquires information presenting the evaluation ranks “2”, “4”, and “6” associated with the store IDs “S03”, “S04”, and “S06” (Step S21). This is for obtaining the evaluation ranks of the stores S03, S04, and S06 eliminated according to the selection condition for the purchase store.

Then, the second outputter 252 shown in FIG. 5 outputs to the LAN card 206 shown in FIG. 3 information presenting the evaluation rank “2”, information presenting the evaluation rank “4”, and information presenting the evaluation rank “6” destined to the store terminals 330, 340, and 360 used by the eliminated stores S03, S04, and S06, respectively (Step S22). Subsequently, the second outputter 252 ends the sales procedure.

Incidentally, the LAN card 206 sends the information presenting the evaluation rank “2”, information presenting the evaluation rank “4”, and information presenting the evaluation rank “6” to the store terminals 330, 340, and 360, respectively.

The store terminal 360 displays on the informer 362 the event of the store S06 being ranked “6th” in the evaluation based on the information received from the sales apparatus 200. The store terminals 330 and 340 similarly displays the event of the stores being ranked “2nd” and “4th” in the evaluation, respectively.

With the above configuration, the sales system 1 informs the eliminated stores that are not selected using any of the different selection conditions of their ranks determined using the selection condition associated with the button operated by the user and used in selecting the store. Therefore, the sales system 1 can urge the employees of the eliminated stores to change their sales modes of the product so as to move up their informed ranks.

### Modified Embodiment 5

In the embodiment, the sales apparatus 200 sends to the selected stores information presenting the selection condition used in selecting the order-placed store with which the purchase order is placed in the Step S12 of the sales procedure shown in FIG. 4, but does not send information presenting the selection condition to the eliminated stores.

In this modified embodiment, the sales apparatus 200 sends to the selected stores and eliminated stores information presenting the selection condition used in selecting the store with which the purchase order is placed in the Step S12 of the sales procedure shown in FIG. 4.

Incidentally, unlike this modified embodiment, another modified embodiment can be configured in which the sales apparatus 200 sends to the order-placed store information presenting the selection condition used in selecting the purchase store, but does not send to any of the selected stores and eliminated stores information presenting the selection condition.

### Modified Embodiment 6

In the embodiment, the sales apparatus 200 selects stores using the selection conditions prestored in FIG. 8.

In this modified embodiment, the sales apparatus 200 creates a new selection condition by combining sales modes that are used a larger number of times than a given number in selection conditions for order-placed stores among multiple sales modes.

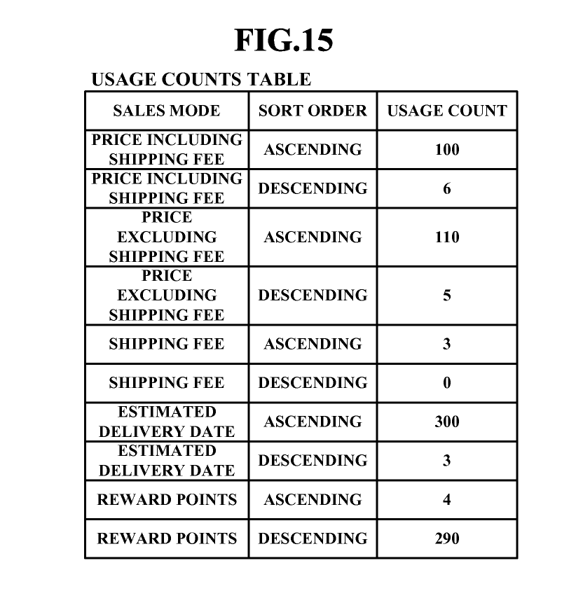

More specifically, the information storage 220 of the sales apparatus 200 shown in FIG. 5 stores a usage count table storing information presenting the number of times a sales mode is used in selecting an order-placed store as shown in FIG. 15.

The usage count table stores multiple records in each of which the header of a column presenting the sales mode in the sales modes table shown in FIG. 7, the sorting order of the column, and the number of times information stored in the column presenting the sales mode is sorted by that order according to the selection condition for the order-placed store are associated.

In this modified embodiment, after executing the Steps S01 to S12 of the sales procedure shown in FIG. 4, the selector 240 of the sales apparatus 200 shown in FIG. 5 executes the following process and then ends the sales procedure.

First, the selector 240 identifies the selection condition for the order-placed store S02 to be “EARLIER ESTIMATED DELIVERY DATE AND LOW PRICE INCLUDING SHIPPING FEE”. Then, the selector 240 determines that information in the column “PRICE INCLUDING SHIPPING FEE” and information in the column “ESTIMATED DELIVERY DATE” were sorted in the ascending order in order to select a store under the selection condition for the order-placed store S02.

Subsequently, the selector 240 updates information stored in the column “USAGE COUNT” of the record storing information presenting “ESTIMATED DELIVERY DATE” in the sales mode column and information presenting “ASCENDING” in the sorting order column to information presenting the count increased by “1” from the usage count presented by the information in the usage count table shown in FIG. 15.

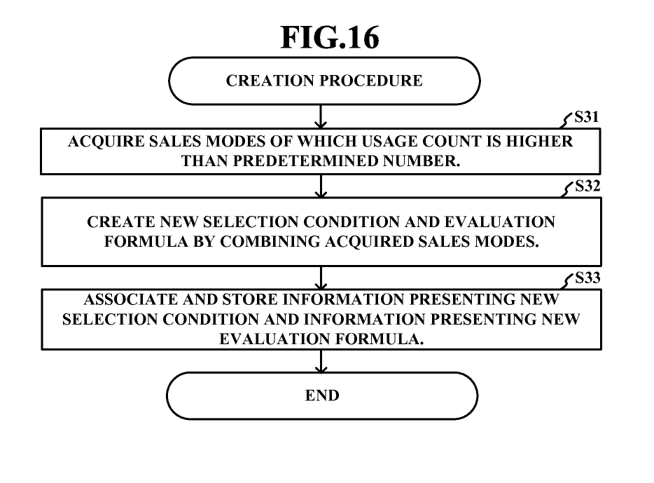

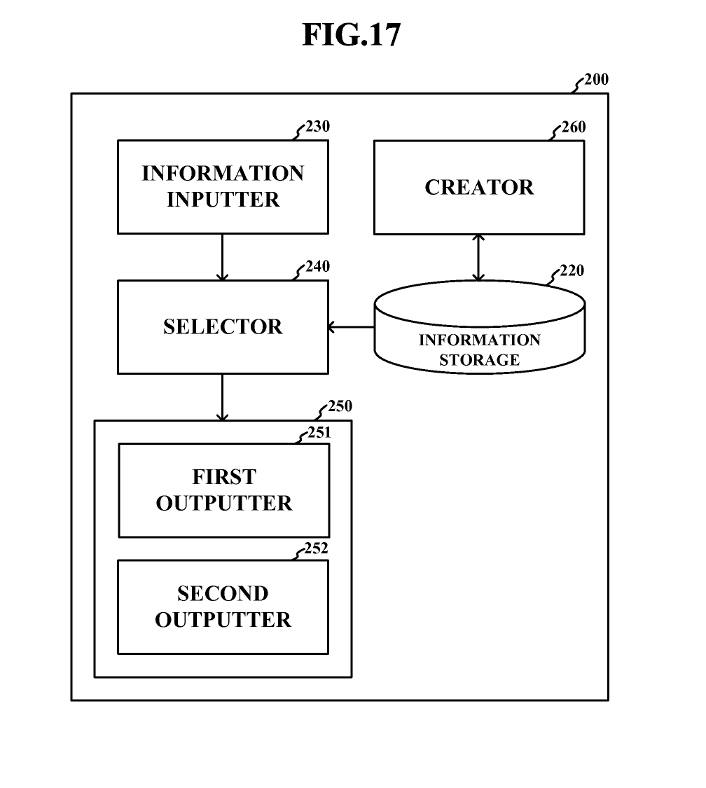

When the system time reaches a preset time, the CPU 201 shown in FIG. 3 executes the creation procedure shown in FIG. 16 to create a new selection condition based on the usage counts stored in the usage count table shown in FIG. 15. As a result, the CPU 201 functions as a creator 260 as shown in FIG. 17.

Starting execution of the creation procedure shown in FIG. 16, the creator 260 reads information presenting a set count prestored in the information storage 220. Then, the creator 260 searches the usage count table shown in FIG. 15 and acquires records in which the usage count is higher than the set count presented by the read information. Then, the creator 260 acquires information presenting the sales mode and information presenting the sorting order stored in the acquired records (Step S31). Here, the explanation is made on the assumption that the set count is “200”.

In the Step S31, the creator 260 acquires the sales mode column “ESTIMATED DELIVERY DATE” and the sorting order “ASCENDING”, which were used “300” times, and the sales mode column “REWARD POINTS” and the sorting order “DESCENDING”, which were used “290” times.

Then, the creator 260 determines that the number of times “300” information in the column “ESTIMATED DELIVERY DATE” is sorted in the “ASCENDING” order is higher than the number of times “290” information in the column “REWARD POINTS” is sorted in the “DESCENDING” order. Therefore, the creator 260 creates a selection condition under which a store of which the estimated delivery date is closer to the system date is ranked higher in evaluation than a store of which the estimated delivery date is far from the system date even though the former grants less points than the latter. More specifically, the creator 260 creates a new selection condition “EARLIER ESTIMATED DELIVERY DATE AND MORE REWARD POINTS” by combining the acquired sales mode column “ESTIMATED DELIVERY DATE” and sorting order “ASCENDING” and the sales mode column “REWARD POINTS” and sorting order “DESCENDING”. Furthermore, the creator 260 creates an evaluation formula “ORDER BY ESTIMATED DELIVERY DATE ASC, REWARD POINTS DESC” for this new selection condition (Step S32).

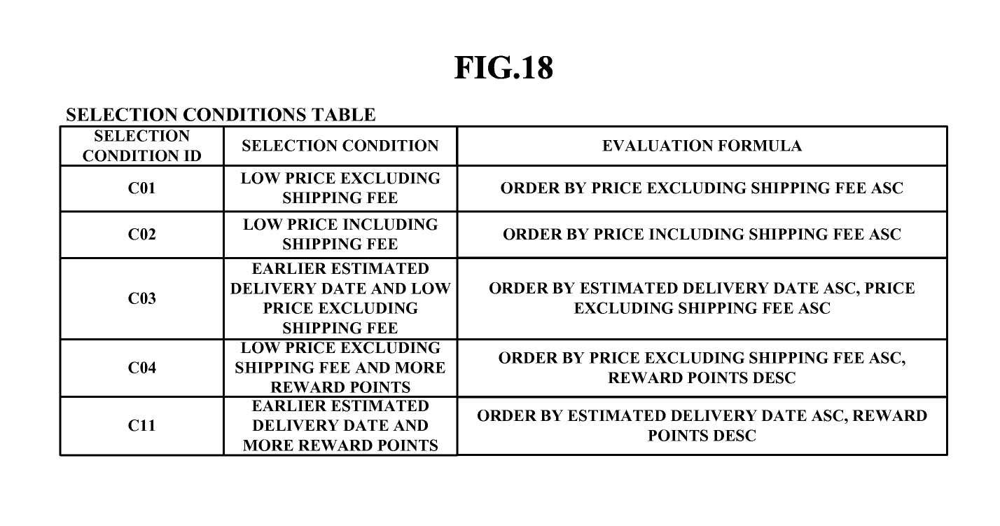

Subsequently, the creator 260 associates selection condition information resenting the new selection condition created with the new selection condition evaluation formula in updating to the table shown in FIG. 18 (Step S33). Subsequently, the creator 260 ends the execution of the creation procedure.

Subsequently, receiving new keyword information from the user terminal 110 or 120, the sales apparatus 200 executes the sales procedure shown in FIG. 4 using the selection conditions table shown in FIG. 18.

With the above configuration, the sales system 1 creates a new selection condition based on the sales mode used in the selection condition for the store with which an order for purchasing a product is placed, and selects the store using the new selection condition created. Therefore, the sales system 1 of this modified embodiment can present a store selling the product in the sales mode more suitable for the user's interest than in the embodiment.

### Modified Embodiment 7

In the embodiment, the sales apparatus 200 selects a stored based on the sales modes prestored in FIG. 7.

In this modified embodiment, the sales apparatus 200 identifies the sales unit of a product at a store from a webpage the store uses for selling the product.

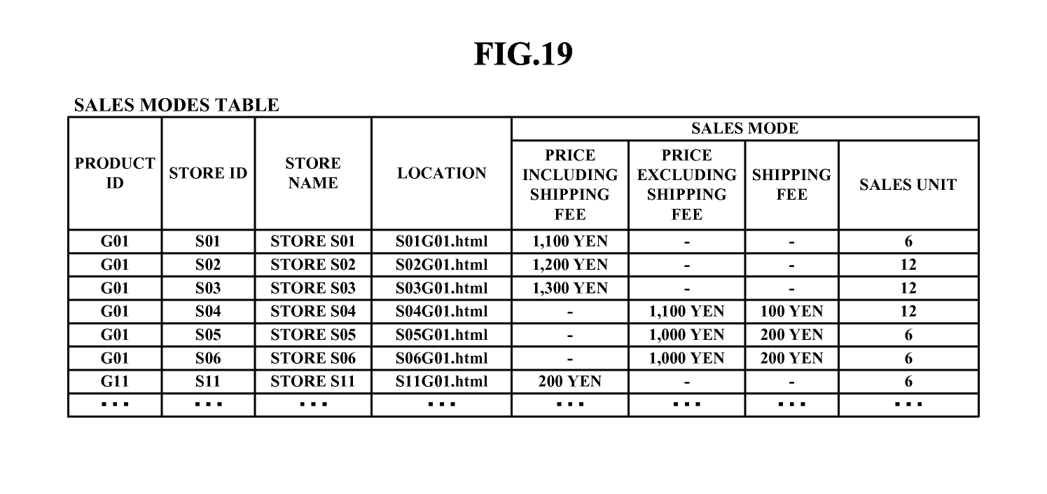

In this modified embodiment, the information storage 220 of the sales apparatus 200 stores a sales modes table as shown in FIG. 19. This sales modes table stores multiple records in each of which a product ID, a store ID, information presenting the store name, information presenting the sales mode, and information presenting the location of the webpage the store uses for selling the product (the location information, hereafter) are associated.

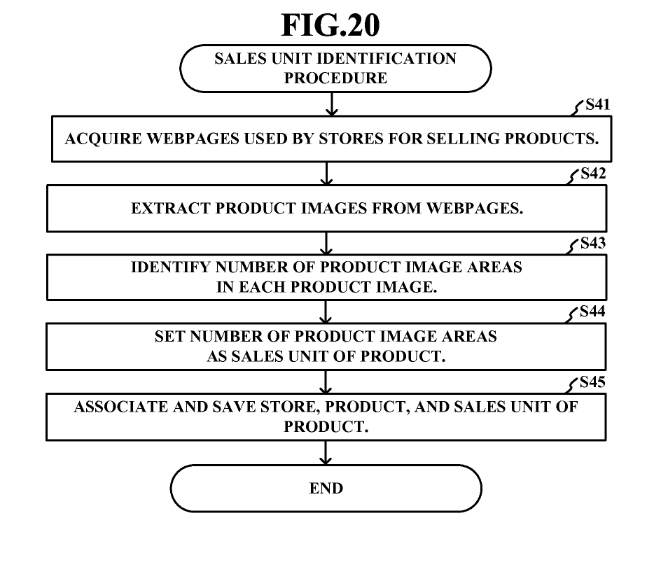

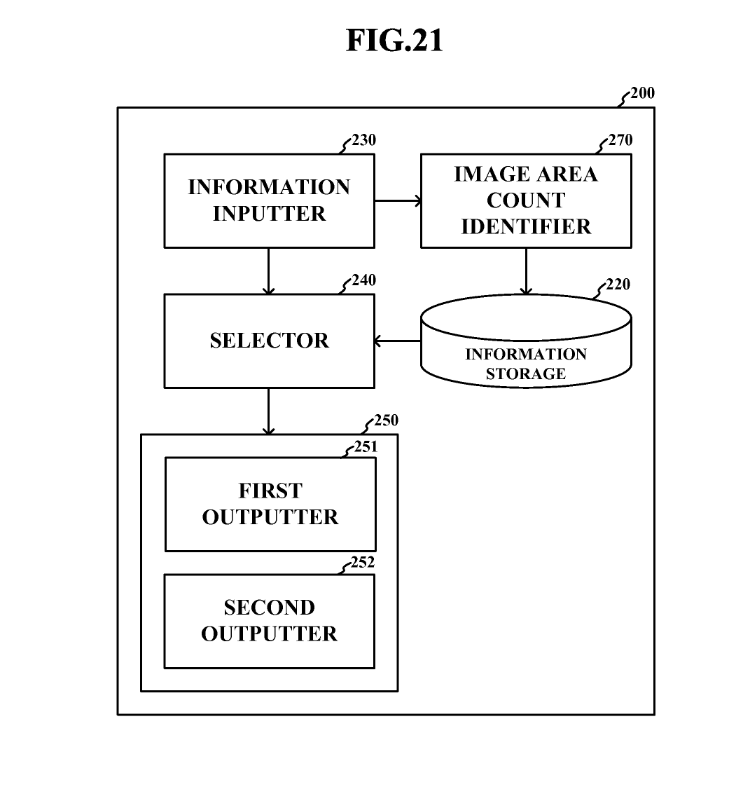

In this modified embodiment, the CPU 201 of the sales apparatus 200 executes the sales unit identification procedure as shown in FIG. 20 when the system time reaches a preset time. The sales unit identification procedure is a procedure to identify the sales unit of a product from the webpage at the location stored in the sales modes table shown in FIG. 19. Executing this procedure, the CPU 201 functions as an image area count identifier 270 as shown in FIG. 21.

As the sales unit identification procedure is executed, the information inputter 230 acquires multiple pieces of location information stored in the sales modes table shown in FIG. 19. Then, the information inputter 230 acquires multiple webpages at the locations presented by the multiple pieces of location information (Step S41).

Subsequently, the image area count identifier 270 extracts a product image presenting the product from each of the multiple webpages acquired in the Step S41 (Step S42). More specifically, the image area count identifier 270 acquires an IMG tag having a given ID from the webpage and acquires a product image using the SRC attribute value or the like of the acquired IMG tag.

Then, the image area count identifier 270 identifies by image analysis one or multiple image areas presenting the product (the product image areas, hereafter) in each of the multiple product images acquired.

The above image analysis is a process to determine an image area of a predetermined size or larger that comprises multiple pixels the difference in pixel value between adjoining ones of which is smaller than a predetermined value to be a product image area.

However, the above image analysis can be a process to determine an image area of a predetermined size or larger that is enclosed by multiple continuous pixels the difference in pixel value between adjoining ones of which is larger than a predetermined value to be a product image area.

Furthermore, the above image analysis can be a process to determine, for example, an area that matches up to an image displaying the product identified by the product ID and stored in the information storage 220 in association with the product ID to be a product image area.

Subsequently, the selector 240 sets the number of product image areas identified by the image area count identifier 270 as the sales unit of the product (Step S44).

Subsequently, the selector 240 associates and stores in the sales modes table shown in FIG. 19 a product ID, a store ID, and information presenting the sales unit of the product identified by the product ID at the store identified by the store ID for each of the identified sales units, and ends the sales unit identification procedure.

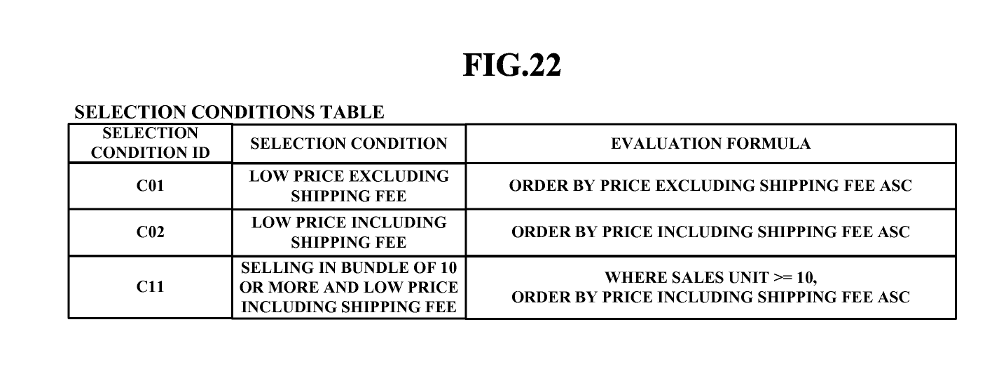

The information storage 220 storing the sales modes table shown in FIG. 19 stores the selection conditions table as shown in FIG. 22. This selection conditions table stores information presenting a bundled sale condition “SELLING IN BUNDLE OF 10 OR MORE AND LOW PRICE INCLUDING SHIPPING FEE” used for selecting a store using the number of pieces in a bundle to sell the product.

Here, “SELLING IN BUNDLE OF 10 OR MORE” means “the sales unit of the product is ‘10’ or more”. Here, the records stored in the sales modes table in FIG. 19 are searched using an SQL “SELECT * FROM SALES MODES TABLE”. The records storing the store ID of a store selling the product in the sales unit of “10” or more among the searched records are the records having a value “10” or higher stored in the column “SALES UNIT” among the records searched using the above SQL.

The SQL command to search for records having a value “10” or higher stored in the column “SALES UNIT” is “WHERE SALES UNIT >=10”. Therefore, the evaluation formula for the selection condition “SELLING IN BUNDLE OF 10 OR MORE AND LOW PRICE INCLUDING SHIPPING FEE” is expressed by a WHERE command and ORDER BY command “WHERE SALES UNIT >=10, ORDER BY PRICE INCLUDING SHIPPING FEE ASC”.

The sales apparatus 200 of this modified embodiment uses the selection conditions table shown in FIG. 22 and the sales modes table shown in FIG. 19 to execute the sales procedure shown in FIG. 4.

The selector 240 of the sales apparatus 200 evaluates the stores S01 to S06 selling the searched product according to the selection condition including the bundled sale condition “SELLING IN BUNDLE OF 10 OR MORE AND LOW PRICE INCLUDING SHIPPING FEE” in the step S05 of the sales procedure.

Here, as shown in the sales modes table in FIG. 19, the stores S02 to S04 among the stores S01 to S06 sell the searched product in a sales unit of “12”. Furthermore, the store S04 does not sell the searched product at a price including shipping fee. The store S02 sells the searched product at a price including shipping fee “1,200 yen”, which is lower by “100 yen” than the store S03.

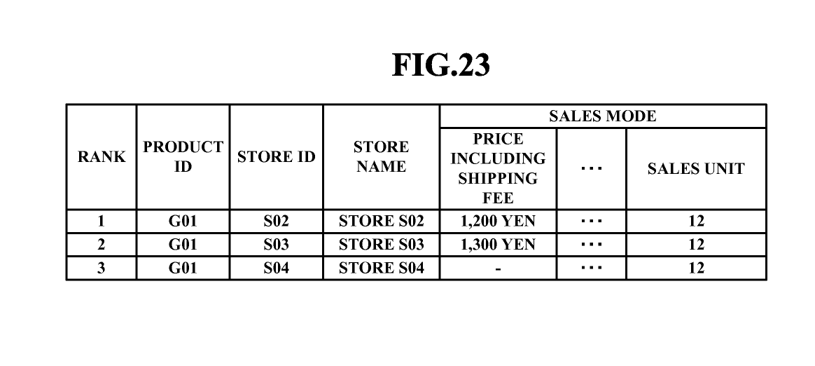

Therefore, the selector 240 of the sales apparatus 200 ranks the stores S02 to S04 in this order and creates the evaluation results table as shown in FIG. 23.

The selector 240 of the sales apparatus 200 selects the store S02 ranked highest according to the selection condition “SELLING IN BUNDLE OF 10 OR MORE AND LOW PRICE INCLUDING SHIPPING FEE” in the Step S06 of the sales procedure.

With the above configuration, the sales system 1 extracts product images from webpages and employs the number of product image areas included in the extracted product images as the number of pieces in a bundle to sell the product. Therefore, the sales system 1 can identify the number of pieces in a bundle to sell a product even if the employee of a store does not specify the number of pieces in a bundle to sell the product.

### Modified Embodiment 8

In the embodiment, the sales apparatus 200 searches the products table shown in FIG. 6 for a product ID based on a search keyword in the Step S02 shown in FIG. 4. Furthermore, the sales apparatus 200 searches the sales modes table shown in FIG. 7 for the store ID of a store selling the product identified by the product ID searched (namely the searched product ID) and information presenting the sales mode of the product at the store based on the searched product ID in the Step S04.

However, this is not restrictive. The sales apparatus 200 can search for the product ID based on the product category in the Step S02.

More specifically, in this modified embodiment, the user conducts an operation on the user terminal 110 to enter the category of a product to search (the searched product category, hereafter). The user terminal 110 enters information presenting the searched product category (the searched product category information, hereafter) in accordance with the user operation and sends the entered, searched product category information to the sales apparatus 200.

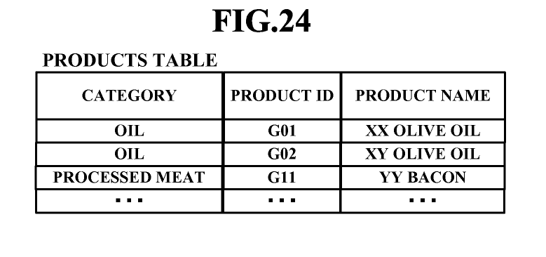

The sales apparatus 200 of this modified embodiment stores a products table as shown in FIG. 24 in place of the products table shown in FIG. 6. The products table shown in FIG. 24 stores multiple records in each of which information presenting a category, the product ID of a product classified in the category, and product name information of the product are associated. Incidentally, one or multiple products are classified in one category.

Receiving the searched product category information from the user terminal 110, the sales apparatus 200 starts to execute the sales procedure shown in FIG. 4, executing the processing of the Step S01.

Subsequently, the sales apparatus 200 searches the products table shown in FIG. 24 for multiple product IDs and product name information associated with information presenting the category identical to the category presented by the searched product category information.

Then, the sales apparatus 200 sends the multiple product IDs and product name information found to the user terminal 110. The user terminal 110 displays the multiple found product names and product IDs in an associated manner based on the received information. Subsequently, the user conducts an operation on the user terminal 110 to select one of the multiple product names or product IDs displayed. The user terminal 110 sends to the sales apparatus 200 the selected product ID or the product ID associated with the selected product name (the selected product ID, hereafter) in accordance with the user operation.

The sales apparatus 200 resumes the sales procedure in FIG. 4 from the Step S03 using the received product ID as the searched product ID. Subsequently, the sales apparatus 200 executes the processing up to the Step S12 and then ends the execution of the sales procedure.

The embodiment and Modified Embodiments 1 to 8 can be combined with each other. Not only can the sales apparatus 200 comprising the configuration for realizing the functions according to the embodiment be provided, but also it is possible to provide a system composed of multiple devices and overall comprising the configuration for realizing the functions according to the embodiment.

Incidentally, not only can the sales apparatus 200 comprising the configuration preinstalled for realizing the functions according to the embodiment be provided, but also it is possible to apply programs to an existing sales apparatus to function as the sales apparatus 200 according to the embodiment. In other words, it is possible to apply the sales program for realizing the functional configurations of the sales apparatus 200 exemplified by the embodiment to a computer (CPU) controlling an existing sales apparatus in an executable manner so as to function as the sales apparatus 200 according to the embodiment.

The above program can be distributed by any method. For example, the program can be stored and distributed on a non-transitory recording medium such as a memory card, CD-ROM, or DVD-ROM, or distributed via a communication medium such as the Internet. Furthermore, the sales method according to the present disclosure can be implemented using the sales apparatus 200 according to the present disclosure.

A preferable embodiment is described in detail above. The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitable for server devices selling products in response to requests from the user ends.

### REFERENCE SIGNS LIST

1 Sales system
10 Computer communication network
110, 120 User terminal
111 Inputter
112 Presenter
200 Sales apparatus
201 CPU
202 ROM
203 RAM
204 Hard disc
205 Media controller
206 LAN card
207 Video card
208 LCD
209 Keyboard
210 Speaker
211 Mouse
212 Bus
220 Information storage
230 Information inputter
240 Selector
250 Information outputter
251 First outputter
252 Second outputter
260 Creator
270 Image area count identifier
310, 320, 330, 340, 350, 360 Store terminal
311, 321, 361 Inputter
312, 322, 362 Informer

1-9. (canceled)

10. A sales system, comprising:
a selector selecting a plurality of stores selling a product a user wishes to purchase by using a plurality of mutually different selection conditions using sales modes of the product;
a presenter presenting to the user the plurality of stores by displaying a plurality of selection objects presenting the plurality of selected stores and the sales modes of the product at the plurality of stores on a purchase order placing screen on which an order for purchasing the product is placed for a store presented by the selected selection object when an operation selecting the selection object displayed on the purchase order placing screen is performed by the user; and
a creator creating a new selection condition using sales modes of the product at the stores presented by the selection object for which the selecting operation is performed by the user; wherein
the selector uses the new selection condition as one of the plurality of selection conditions when the new selection condition is created.

11. The sales system according to claim 10, further comprising:
an inputter entering operation information presenting which selection object is selected by the user; and
a display having a store terminal used by the store presented by the selection object for which the selecting operation is performed, and displaying that the user has placed the order for purchasing the product.

12. The sales system according to claim 11, wherein
the display shows the selection condition for selecting the store using the sales modes that is presented by the operated selection object to the plurality of selected stores.

13. The sales system according to claim 11, wherein
the selector selects the plurality of stores based on the ranks of the stores selling the product the user wishes to purchase that are given using the sales modes of the product at the stores and the plurality of mutually different conditions for selecting the stores individually using the sales modes, and
the display shows the ranks given using the selection condition used in selecting the store presented by the operated selection object to stores different from the plurality of selected stores among the stores selling the product the user withes to purchase.

14. The sales system according to claim 12, wherein
the selector selects the plurality of stores based on the ranks of the stores selling the product the user wishes to purchase that are given using the sales modes of the product at the stores and the plurality of mutually different conditions for selecting the stores individually using the sales modes, and
the display shows the ranks given using the selection condition used in selecting the store presented by the operated selection object to stores different from the plurality of selected stores among the stores selling the product the user withes to purchase.

15. The sales system according to claim 10, wherein
at least one of the plurality of selection conditions is a bundled sale condition using a number of pieces in a bundle to sell the product,
an area count identifier identifying a number of image areas presenting the product in each of images presenting the product that are extracted from webpages used by the plurality of stores for selling the product is further provided, and
the selector selects a store satisfying at least one bundled sale condition from the stores selling the product the user wishes to purchase on an assumption that the identified number of image areas is the number of pieces in the bundle to sell the product.

16. A sales apparatus, comprising:
a selector selecting a plurality of stores selling a product a user wishes to purchase by using a plurality of mutually different selection conditions using sales modes of the product;
a first outputter outputting to a user terminal used by the user information presenting a plurality of selection objects presenting the plurality of selected stores and the sales modes of the product at the plurality of stores, the information being displayed on a purchase order placing screen on which an order for purchasing the product is placed for a store presented by the selected selection object when an operation selecting the selection object displayed on the purchase order placing screen is performed by the user; and
a creator creating a new selection condition using sales modes of the product at the stores presented by the selection object for which the selecting operation is performed by the user; wherein
the selector uses the new selection condition as one of the plurality of selection conditions when the new selection condition is created.

17. The sales apparatus according to claim 16, further comprising:
an information inputter inputting operation information presenting which selection object is operated by the user from a terminal device; and
a second outputter outputting information indicating that the user has placed the order for purchasing the product with its destination set to a store terminal used by the store presented by the selection object presented by the output operation information.

18. A computer-readable non-transitory recording medium on which a sales program is recorded that allows a computer to function as:
a selector selecting a plurality of stores selling a product a user wishes to purchase by using a plurality of mutually different selection conditions using sales modes of the product;
a first outputter outputting to a user terminal used by the user information presenting a plurality of selection objects presenting the plurality of selected stores and the sales modes of the product at the plurality of stores, the information being displayed on a purchase order placing screen on which an order for purchasing the product is placed for a store presented by the selected selection object when an operation selecting the selection object displayed on the purchase order placing screen is performed by the user; and
a creator creating a new selection condition using sales modes of the product at the stores presented by the selection object for which the selecting operation is performed by the user; wherein
the selector uses the new selection condition as one of the plurality of selection conditions when the new selection condition is created.

19. The computer-readable non-transitory recording medium according to claim 18 on which a sales program is recorded that allows a computer to further function as:
an information inputter inputting operation information presenting which selection object is operated by the user from a terminal device; and
a second outputter outputting information indicating that the user has placed the order for purchasing the product with its destination set to a store terminal used by the store presented by the selection object presented by the output operation information.

20. A sales method, comprising:
a selection step of selecting a plurality of stores selling a product a user wishes to purchase by using a plurality of mutually different selection conditions using sales modes of the product;
a first output step of outputting to a user terminal used by the user information presenting a plurality of selection objects presenting the plurality of selected stores and the sales modes of the product at the plurality of stores, the information being displayed on a purchase order placing screen on which an order for purchasing the product is placed for a store presented by the selected selection object when an operation selecting the selection object displayed on the purchase order placing screen is performed by the user; and
a creation step of creating a new selection condition using sales modes of the product at the stores presented by the selection object for which the selecting operation is performed by the user; wherein
in the selection step, the new selection condition is used as one of the plurality of selection conditions when the new selection condition is created.

21. The sales method according to claim 20, further comprising:
an information input step of inputting operation information presenting which selection object is operated by the user from a terminal device; and
a second output step of outputting information indicating that the user has placed the order for purchasing the product with its destination set to a store terminal used by the store presented by the selection object presented by the output operation information.
